(19) United States
(12) Patent Application Publication
(10) Pub. No.: US 2022/0305733 A1
(43) Pub. Date: Sep. 29, 2022

(54) POWDER SUPPLY ASSEMBLY WITH LEVEL SENSOR AND MULTIPLE STAGES WITH REFILLING

(71) Applicant: Nikon Corporation, Tokyo (JP)

(72) Inventors: Victor Itliong Solidum, Hayward, CA (US); Kristopher Daniel Sanford, Oakland, CA (US); Alton Hugh Phillips, Oro Valley, AZ (US); Lexian Guo, Union City, CA (US); Patrick Shih Chang, San Francisco, CA (US); Johnathan Agustin Marquez, San Francisco, CA (US); Yeong-Jun Choi, San Ramon, CA (US)

(21) Appl. No.: 17/701,098

(22) Filed: Mar. 22, 2022

Related U.S. Application Data
(60) Provisional application No. 63/165,405, filed on Mar. 24, 2021.

(51) Int. Cl. B29C 64/329; B29C 64/153; B29C 64/245; B29C 64/255; B29C 64/268; B29C 64/386; B33Y 30/00; B33Y 40/00; B33Y 50/00; G01F 23/263; G01F 23/20; G01F 23/292

(52) U.S. Cl. CPC B29C 64/329; B29C 64/153; B29C 64/245; B29C 64/255; B29C 64/268; B29C 64/386; B33Y 30/00; B33Y 40/00; B33Y 50/00; G01F 23/266; G01F 23/265; G01F 23/205; G01F 23/2921; B29K 2995/0006; B33Y 70/00

(57) ABSTRACT

A level sensor assembly (552) for estimating a level of a dielectric powder (412) in a container assembly (544) includes a first electrode member (554) that is coupled to the container assembly (544); a second electrode member (556) that is coupled to the container assembly (544): and a control system (424). The second electrode member (556) is spaced apart from the first electrode member (554) and configured so that powder (512) in the container assembly (544) is positioned at least partly between the electrode members (554) (556). The control system (424) utilizes a capacitance between the electrode members (554) (556) to estimate the level of the powder (512) in the container assembly (544).

### RELATED APPLICATIONS

This application claims priority on U.S. Provisional Application No: 63/165,405 filed on Mar. 24, 2021, and entitled “POWDER SUPPLY ASSEMBLY WITH LEVEL SENSOR AND MULTIPLE STAGES WITH REFILLING”. As far as permitted the contents of U.S. Provisional Application No: 63/165,405 are incorporated in their entirety herein by reference.

### Related Applications

As far as permitted the contents of PCT Application No: PCT/US2020/040498 entitled “POWDER SUPPLY ASSEMBLY FOR ADDITIVE MANUFACTURING” filed on Jul. 1, 2020 are incorporated herein by reference.

### BACKGROUND

Three-dimensional printing systems are used to print three-dimensional objects. Existing three-dimensional printing systems are relatively slow, have a low throughput, are expensive to operate, and/or generate excessive waste. There is a never ending search to increase the speed, operation, the throughput and reduce the cost of operation for three-dimensional printing systems.

For example, in a metal powder three-dimensional printing system, the powder must be supplied in a consistent and continuous manner. Unfortunately, materials such as fine powders can adhere or clump together in supply containers or hoppers, making it difficult to evenly deposit powder layers on the part and maintain consistent powder flow. Stated in another fashion, the metal powder is prone to a phenomenon known as “bridging,” where the powder tends to form connections with itself and any non-vertical surface and stop flowing.

Accordingly, there exists a need for improved material supply assembly that accurately delivers the powder in the three-dimensional printing system.

### SUMMARY

A level sensor assembly for estimating a level of a dielectric powder in a container assembly includes (i) a first electrode member that is coupled to the container assembly; (ii) a second electrode member that is coupled to the container assembly, the second electrode member being spaced apart from the first electrode member and configured so that powder in the container assembly is positioned at least partly between the electrode members; and (iii) a control system that utilizes a capacitance between the electrode members to estimate the level of the powder in the container assembly.

In any or all of the disclosed implementations, the control system can include a first integrated circuit that generates an oscillating wave output that corresponds to the capacitance between the electrode members.

In any or all of the disclosed implementations, the first integrated circuit generates an oscillating, square wave output that corresponds to the capacitance between the electrode members. The first integrated circuit can include a 555 timer.

In any or all of the disclosed implementations, the control system can include a second integrated circuit that determines a frequency of the oscillating wave output. The second integrated circuit can include a field-programmable gate array.

In any or all of the disclosed implementations, the control system can estimate the level of the powder in the container assembly based on the frequency of the oscillating wave output.

In another implementation, a powder supply assembly for supplying powder to a build platform of a processing machine for building a three-dimensional object from a dielectric powder includes a container assembly that retains the powder, and the level sensor assembly coupled to the container assembly. In this design, the level sensor assembly estimates the level of the dielectric powder in the container assembly.

In any or all of the disclosed implementations, the powder supply assembly can include a first container subassembly and a second container subassembly; and the level sensor assembly can estimate the level of the dielectric powder in at least one of the container subassemblies.

In another implementation, a processing machine for building a three-dimensional object from powder includes (i) a build platform; (ii) the powder supply assembly described herein; and (iii) an energy system that directs an energy beam at a portion of the powder on the build platform to form a portion of the object.

In another implementation, a powder supply assembly for supplying powder to a build platform of a processing machine for building a three-dimensional object from the powder includes (i) a first container subassembly; (ii) a second container subassembly that retains the powder, the second container subassembly including a refill outlet; and (iii) a transfer system that transfers powder from the second container subassembly to the first container subassembly. The transfer system can include a transfer slope, and a slope actuator assembly that moves the transfer slope between (i) a non-flow position in which powder does not flow from the refill outlet and is not transferred to the first container subassembly; and (ii) a flow position in which powder flows from refill outlet and is transferred to the first container subassembly.

A number of different powder supply assemblies are disclosed herein. As an overview, these powder supply assemblies are uniquely designed to accurately, efficiently, evenly, and quickly distribute the powder onto the build platform. This will improve the accuracy of the built object, and reduce the time required to form the built object.

In any or all of the disclosed implementations, in the non-flow position, the transfer slope can be positioned adjacent to the refill outlet, and/or in the flow position, the transfer slope can be positioned spaced apart from the refill outlet.

In any or all of the disclosed implementations, the slope actuator assembly can move the transfer slope linearly between the flow position and the non-flow position.

In any or all of the disclosed implementations, the slope actuator can pivot the transfer slope between the flow position and the non-flow position.

In any or all of the disclosed implementations, the refill outlet is an outlet angle, and in the non-flow position, the transfer slope is at a first slope angle that is approximately equal to the outlet angle.

In any or all of the disclosed implementations, in the flow position, the transfer slope can be at a second slope angle that is approximately equal to the outlet angle. Alternatively, in any or all of the disclosed implementations, in the flow position, the transfer slope is at a second slope angle that is different from the outlet angle.

In any or all of the disclosed implementations, the level sensor assembly provided herein can monitor a powder level in at least one of the container subassemblies.

In another implementation, a powder supply assembly for supplying powder to a build platform of a processing machine for building a three-dimensional object from the powder includes (i) a first container subassembly; (ii) a second container subassembly that retains the powder, the second container subassembly including a refill outlet; and (iii) a transfer system that transfers powder from the second container subassembly to the first container subassembly. The transfer system can include a transfer slope, and a vibration system that selectively vibrates the transfer slope to selectively control the flow of the powder from the refill outlet of the second container subassembly.

In any or all of the disclosed implementations, the transfer slope can be positioned spaced apart from the refill outlet.

In any or all of the disclosed implementations, the refill outlet is at an outlet angle, and the transfer slope is at a slope angle that is approximately equal to the outlet angle.

In another implementation, a powder supply assembly for supplying powder to a build platform of a processing machine for building a three-dimensional object from the powder includes (i) a first container subassembly having a container inlet having a container longitudinal axis; (ii) a second container subassembly that retains the powder, the second container subassembly including a refill outlet; and (iii) a transfer system that receives powder from the refill outlet and transfers the powder to the first container subassembly. The transfer system can include (i) a transfer slope that extends from the refill outlet to the container inlet, and (ii) a slope aperture assembly; wherein powder from the refill outlet slides down the transfer slope and falls through the slope aperture assembly to be distributed along the container longitudinal axis of the container inlet.

In any or all of the disclosed implementations, the slope aperture assembly includes at least one slope aperture that extends through the transfer slope.

In any or all of the disclosed implementations, the slope aperture assembly includes a plurality of slope apertures that extends through the transfer slope, and the slope apertures can be spaced apart along an aperture axis. The aperture axis can be substantially parallel to the container longitudinal axis. Moreover, the aperture axis can be diagonal to a slope longitudinal axis of the transfer slope.

In still another implementation, a powder supply assembly for supplying powder to a build platform of a processing machine for building a three-dimensional object from the powder includes (i) a first container subassembly that deposits the powder on the build platform, the first container subassembly having a container inlet; (ii) a second container subassembly that retains the powder, the second container subassembly including a refill outlet; and (iii) a resilient assembly that supports the first container subassembly.

In any or all of the disclosed implementations, the amount of powder in the first container subassembly influences a position of the first container subassembly relative to the second container subassembly.

In any or all of the disclosed implementations, a sensor system can estimate the amount of powder in the first container subassembly based on the position of the first container subassembly.

In any or all of the disclosed implementations, the resilient assembly can couple the first container subassembly to the second container subassembly.

In any or all of the disclosed implementations, a container valve can selectively control the flow of the powder from the second container subassembly to the first container subassembly.

In any or all of the disclosed implementations, a coupler assembly can couple the first container subassembly to the container valve. In this design, movement of the first container subassembly away from the second subassembly causes the coupler assembly to urge the container valve to open, and movement of the first container subassembly towards the second subassembly causes the coupler assembly to urge the container valve to close.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1A is a simplified side view of an implementation of a processing machine;

FIG. 1B is a simplified top view of a portion of the processing machine of FIG. 1A;

FIG. 2 is a simplified top view of a portion of another implementation of the processing machine;

FIG. 3 is a simplified top view of a portion of still another implementation of the processing machine;

FIG. 4A is a simplified perspective view of a portion of still another implementation of the processing machine;

FIG. 4B is a cut-away view taken on line 4B-4B in FIG. 4A;

FIG. 4C is a cut-away view of a first container subassembly when there is no powder flow;

FIG. 4D is a cut-away view taken from line 4D-4D in FIG. 4A, without the powder;

FIG. 4E is a simplified top view of the first container subassembly;

FIG. 4F is a top view of one implementation of a flow controller;

FIG. 4G is a side view a flow structure;

FIG. 5A is a top perspective view of a portion of another implementation of a powder supply assembly;

FIG. 5B is a cross-sectional front elevation view taken along line 5B-5B of FIG. 5A;

FIG. 5C is a simplified schematic view a capacitance sensing circuit having features of the present invention;

FIG. 6A is a simplified side view, in partial cut-away of another implementation of the powder supply assembly;

FIG. 6B is a simplified side view, in partial cut-away of the powder supply assembly of FIG. 6A in a flow position;

FIG. 7A is a simplified side view, in partial cut-away of still another implementation of the powder supply assembly;

FIG. 7B is a simplified side view, in partial cut-away of the powder supply assembly of FIG. 7A in a flow position;

FIG. 8A is a simplified side view, in partial cut-away of another implementation of the powder supply assembly;

FIG. 8B is a simplified side view, in partial cut-away of the powder supply assembly of FIG. 8A in a flow position;

FIG. 9A is a simplified perspective view, of a portion of yet another implementation of the powder supply assembly;

FIG. 9B is a simplified top view of a portion of the powder supply assembly of FIG. 9A;

FIG. 9C is an alternative, simplified perspective view, of a portion of the powder supply assembly of FIG. 9A;

FIG. 10A is a simplified side view, of still another implementation of the powder supply assembly with a first container subassembly being refilled;

FIG. 10B is a simplified side view, of the powder supply assembly of FIG. 10A with the first container subassembly not being refilled;

FIG. 11A is a simplified side view, of still another implementation of the powder supply assembly with the first container subassembly being refilled;

FIG. 11B is a simplified side view, of the powder supply assembly of FIG. 11A with the first container subassembly not being refilled;

FIG. 12A is a simplified side view, in partial cut-away, of still another implementation of the powder supply assembly with a first container subassembly being refilled, and a powder bed assembly;

FIG. 12B is a simplified side view, in partial cut-away, of the powder supply assembly of FIG. 12A with the first container subassembly still being refilled, and the powder bed assembly;

FIG. 12C is a simplified side view, in partial cut-away, of the powder supply assembly of FIG. 12A with the first container subassembly being full, and the powder bed assembly; and

FIG. 13 is a simplified side view, in partial cut-away, of yet another implementation of the powder supply assembly with a first container subassembly being refilled, and a powder bed assembly.

### DESCRIPTION

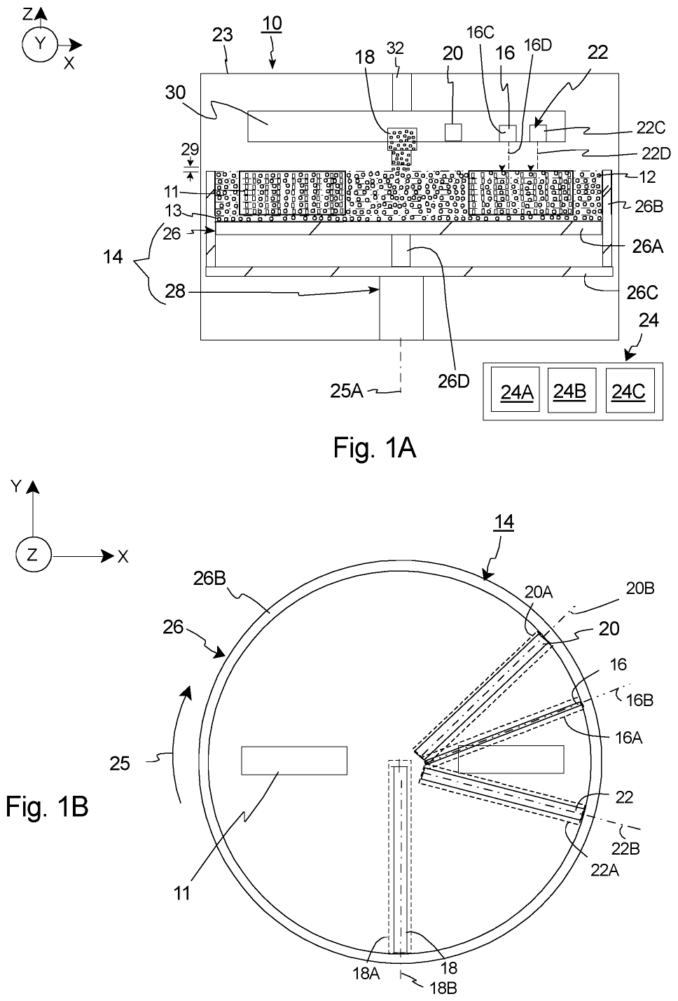

FIG. 1A is a simplified schematic side illustration of a processing machine 10 that may be used to manufacture one or more three-dimensional objects 11 (each illustrated as box). As provided herein, the processing machine 10 can be an additive manufacturing system, e.g. a three-dimensional printer, in which powder 12 (illustrated as small circles) in a series of powder layers 13 (illustrated as dashed horizontal lines) is joined, melted, solidified, and/or fused together to manufacture one or more three-dimensional object(s) 11 (two are illustrated). In FIG. 1A, each of the objects 11 includes a plurality of small squares that represent the joining of the powder 12 to form the object 11.

The type of three-dimensional object(s) 11 manufactured with the processing machine 10 may have various shapes or geometries. As a non-exclusive example, the three-dimensional object 11 may be a metal part, or another type of part, for example, a resin, plastic, or a ceramic part, etc. The three-dimensional object 11 may also be referred to as a “built part”.

The type of powder 12 joined and/or fused together may be varied to suit the desired properties of the object(s) 11. As a non-exclusive example, the powder 12 may include metal powder grains (e.g., including one or more of titanium, aluminum, vanadium, chromium, copper, stainless steel, or other suitable metals) or alloys for metal three-dimensional printing. Alternatively, in certain implementations, the powder 12 may be non-metal powder, plastic, polymer, glass, ceramic powder, organic powder, inorganic powder, or any other material known to people skilled in the art. The powder 12 may also be referred to as “material” or “powder particles”.

A number of different designs of the processing machine 10 are provided herein. In certain implementations, the processing machine 10 includes (i) a powder bed assembly 14; (ii) a pre-heat device 16; (iii) a powder supply assembly 18 (illustrated as a box); (iii) a measurement device 20 (illustrated as a box); (iv) an energy system 22 (illustrated as a box); and (v) a control system 24 (illustrated as a box) that cooperate to make each three-dimensional object 11. The design of each of these components may be varied pursuant to the teachings provided herein. Further, the positions of the components of the processing machine 10 may be different than that illustrated in FIG. 1. Moreover, the processing machine 10 can include more components or fewer components than illustrated in FIG. 1A. For example, the processing machine 10 can include a cooling device (not shown in FIG. 1A) that uses radiation, conduction, and/or convection to cool the powder 12. Alternatively, for example, the processing machine 10 can be designed without the pre-heat device 16 and/or the measurement device 20.

A number of different powder supply assemblies 18 are disclosed herein. As an overview, these powder supply assemblies 18 are uniquely designed to accurately, uniformly, efficiently, evenly, and quickly distribute the powder layers 13 onto the powder bed assembly 14. Further, in certain implementations, the powder supply assembly 18 distributes the powder 12 over a relatively large powder bed assembly 14. This will improve the accuracy of the built object 11, and reduce the time required to form the built object 11.

In certain implementations, the powder supply assembly 18 is a multiple stage delivery system that accurately delivers the powder 12 to the powder bed assembly 14. Additionally or alternatively, the powder supply assembly 18 includes a unique powder level sensor that monitors the level of powder in at least a portion of the powder supply assembly 18. Additionally or alternatively, the powder supply assembly 18 includes a unique refilling and transfer system for refilling the multiple stage delivery system.

The thickness of each powder layer 13 can be varied to suit the manufacturing requirements. In alternative, non-exclusive examples, one or more (e.g. all) of the powder layers 13 can have a uniform layer thickness (along the Z axis) of approximately twenty, thirty, forty, fifty, sixty, seventy, eighty, or ninety, or one hundred microns. However, other layer thicknesses are possible. Particle sizes of the powder 12 can be varied. In one implementation, a common particle size is approximately fifty microns. Alternatively, in other non-exclusive examples, the particle size can be approximately twenty, thirty, forty, sixty, seventy, eighty, or ninety, or one hundred microns. However, other powder particle sizes are possible.

A number of Figures include an orientation system that illustrates an X axis, a Y axis that is orthogonal to the X axis, and a Z axis that is orthogonal to the X and Y axes. It should be noted that any of these axes can also be referred to as the first, second, and/or third axes. Further, as used herein, movement with six degrees of freedom shall mean along and about the X, Y, and Z axes.

In FIG. 1A, a portion of the powder bed assembly 14 is illustrated in cut-away so that the powder 12, the powder layers 13 and the object 11 are visible. With the present design, one or more objects 11 can be simultaneously made with the processing machine 10.

It should be noted that any of the processing machines 10 described herein may be operated in a controlled environment, e.g. such as a vacuum, using an environmental chamber 23 (illustrated in FIG. 1A as a box). For example, one or more of the components of the processing machine 10 can be positioned entirely or partly within the environmental chamber 23. Alternatively, at least a portion of one or more of the components of the processing machine 10 may be positioned outside the environmental chamber 23. Still alternatively, the processing machine 10 may be operated in non-vacuum environment such as inert gas (e.g., nitrogen gas or argon gas) environment.

FIG. 1B is a simplified top view of a portion of the powder bed assembly 14 of FIG. 1A and the three-dimensional objects 11. FIG. 1B also illustrates (i) the pre-heat device 16 (illustrated as box) and a pre-heat zone 16A (illustrated with dashed lines) which represents the approximate area in which the powder 12 can be pre-heated with the pre-heat device 16; (ii) the powder supply assembly 18 (illustrated as a box) and a deposit zone 18A (illustrated in phantom) which represents the approximate area in which the powder 12 can be added and/or spread to the powder bed assembly 14 by the powder supply assembly 18; (iii) the measurement device 20 (illustrated as a box) and a measurement zone 20A (illustrated in phantom) which represents the approximate area in which the powder 12 and/or the object 11 can be measured by the measurement device 20; and (iv) the energy system 22 (illustrated as a box) and an energy zone 22A which represents the approximate area in which the powder 12 can be melted and fused together by the energy system 22.

It should be noted that these zones may be spaced apart differently, oriented differently, or positioned differently from the non-exclusive example illustrated in FIG. 1B. Additionally, the relative sizes of the zones 16A, 18A, 20A, 22A may be different than what is illustrated in FIG. 1B.

In FIGS. 1A and 1B, in certain implementations, the processing machine 10 can be operated so that there is substantially constant relative motion along a moving direction 25 (illustrated by an arrow) between the object(s) 11 being formed and one or more of the pre-heat device 16, the powder supply assembly 18, the measurement device 20, and the energy system 22. The moving direction 25 may include a rotation direction about a rotation axis 25A. With this design, the powder 12 may be deposited and fused relatively quickly. This allows for the faster forming of the object(s) 11, increased throughput of the processing machine 10, and reduced cost for the object(s) 11.

In the implementation illustrated in FIG. 1A and 1B, the powder bed assembly 14 includes (i) a powder bed 26 that supports the powder 12 and the object(s) 11 while being formed, and (ii) a device mover 28 (e.g. one or more actuators) that selectively moves the powder bed 26. In this non-exclusive implementation, the powder bed 26 includes a build platform 26A, a support side wall 26B that extends upward around a perimeter of the support surface 26A, a support base 26C that supports the support side wall 26B, and a platform mover 26D. In this implementation, the build platform 26A can be moved linearly downward as each subsequent powder layer 12 is added relative to the support side wall 26B with the platform mover 26D (e.g. a linear motor, a fine pitch thread, or other actuator). Stated in another fashion, the build platform 26A can be moved somewhat similar to a piston relative to the support side wall 26B which act like as the piston's cylinder wall.

In alternative, non-exclusive implementations, the build platform 26A can be (i) flat, circular disk shaped for use with a corresponding support side wall 26B that is circular tube shaped; (ii) flat rectangular shaped for use with a corresponding support side wall 26B that is rectangular tube shaped, or (iii) polygonal-shaped for use with a corresponding support side wall 26B that is polygonal tube shaped. Alternatively, other shapes of the build platform 26A and the support side wall 26B may be utilized. Still alternatively, in another implementation, the support side wall 26B can be built concurrently as a custom shape around the object 11, while the object 11 is being built.

The device mover 28 can move the powder bed 26 relative to the pre-heat device 16 (and the pre-heat zone 16A), the powder supply assembly 18 (and the deposit zone 18A), the measurement device 20 (and the measurement zone 20A), and the energy system 22 (and the irradiation zone 22A). This allows nearly all of the rest of the components of the processing machine 10 to be fixed while the powder bed 26 is moved. For example, the device mover 28 can rotate the powder bed 26 about the rotation axis 25A relative to the pre-heat device 16, the powder supply assembly 18, the measurement device 20, and the energy system 22.

In one implementation, the device mover 28 can move the powder bed 26 at a substantially constant or variable angular velocity about the rotation axis 25A. As alternative, non-exclusive examples, the device mover 28 may move the powder bed 26 at a substantially constant angular velocity of at least approximately 1, 2, 5, 10, 20, 30, 60, 100 or more revolutions per minute (RPM). Stated in a different fashion, the device mover 28 may move the powder bed 26 at a substantially constant angular velocity of between one and one hundred revolutions per minute.

Additionally or alternatively, the device mover 28 may move the powder bed 26 in a stepped or other fashion. For example, it may be desired to speed up or slow down the rotation of the powder bed 26 for some sections, either as part of a normal cycle like increase time under pre-heater, or as a smart corrective action during the build (e.g. to repair a defect). The rotation axis 25A may be aligned along with gravity direction, and may be along with an inclination direction about the gravity direction. Still alternatively, the device mover 28 can be designed to move the powder bed 26 linearly along the Y and/or X axis.

In FIG. 1A, the device mover 28 can include one or more rotary motors or other type of actuator.

The powder 12 used to make the object 11 is deposited onto the powder bed 26 in a series of powder layers 13. Depending upon the design of the processing machine 10, the powder bed 26 with the powder 12 may be very heavy. With the present design, this large mass may be rotated at a constant or substantially constant speed to avoid accelerations and decelerations, and the required motion is a continuous rotation of a large mass, with no non-centripetal acceleration other than at the beginning and end of the entire exposure process. The melting process may be performed during the period when moving velocity is constant.

The pre-heat device 16 selectively preheats the powder 12 in the pre-heat zone 16A that has been deposited on the powder bed 26 during a pre-heat time. In certain embodiments, the pre-heat device 16 heats the powder 12 to a desired preheated temperature in the pre-heat zone 16A when the powder 12 is moved through the pre-heat zone 16A. The number of the pre-heat devices 16 may be one or plural.

In one embodiment, the pre-heat device 16 is positioned along a pre-heat axis (direction) 16B and is arranged between the measurement device 20 and the energy system 22. However, the pre-heat device 16 can be positioned at another location.

The design of the pre-heat device 16 and the desired preheated temperature may be varied. In one embodiment, the pre-heat device 16 may include one or more pre-heat energy source(s) 16C that direct one or more pre-heat beam(s) 16D at the powder 12. Each pre-heat beam 16D may be steered as necessary. As alternative, non-exclusives examples, each pre-heat energy source 16C may be an electron beam system, a mercury lamp, an infrared laser, a supply of heated air, thermal radiation system, a visual wavelength optical system or a microwave optical system. The desired preheated temperature may be 50% 75% 90% or 95% of the melting temperature of the powder material used in the printing. It is understood that different powders have different melting points and therefore different desired pre-heating points. As non-exclusive examples, the desired preheated temperature may be at least 300, 500, 700, 900, or 1000 degrees Celsius. Energy input may also vary dependent on melt duty of previous layers, specific regions on a layer, or progress though the build.

The powder supply assembly 18 deposits the powder 12 onto the powder bed 26. In certain embodiments, the powder supply assembly 18 supplies the powder 12 to the powder bed 26 in the deposit zone 18A while the powder bed 26 is being moved to form each powder layer 13 on the powder bed 26.

In one implementation, the powder supply assembly 18 extends along a powder supply axis (direction) 18B and is arranged between the measurement device 20 and the energy system 22. The number of the powder supply assemblies 18 may be one or plural.

With the present design, the powder supply assembly 18 deposits the powder 12 onto the powder bed assembly 14 to sequentially form each powder layer 13. Once a portion of the powder layer 13 has been melted with the energy system 22, the powder supply assembly 18 evenly and uniformly deposits another (subsequent) powder layer 13.

It should be noted that each three-dimensional object 11 is formed through consecutive fusions of consecutively formed cross sections of powder 12 in one or more powder layers 13. For simplicity, the example of FIG. 1A illustrates only a few, separate, stacked powder layers 13. However, it should be noted that depending upon the design of the object 11, the building process will require numerous powder layers 13.

A number of alternative powder supply assemblies 18 are described in more detail below. In these embodiments, the powder supply assembly 18 is an overhead powder supply that supplies the powder 12 onto the top of the powder bed assembly 14.

The measurement device 20 inspects and monitors the melted (fused) layers of the object 11 as that are being built, and/or the deposition of the powder layers 13. The number of the measurement devices 20 may be one or plural. For example, the measurement device 20 can measure both before and after the powder 12 is distributed.

As non-exclusive examples, the measurement device 20 may include one or more optical elements such as a uniform illumination device, fringe illumination device (structured illumination device), cameras that function at one or more wavelengths, lens, interferometer, or photodetector, or a non-optical measurement device such as an ultrasonic, eddy current, or capacitive sensor.

In one implementation, the measurement device 20 extends along a measurement axis 20B and is arranged between the powder supply assembly 18 and the pre-heat device 16, however, the measurement device 20 may be alternatively located.

The energy system 22 selectively heats and melts the powder 12 in the energy zone 22A to sequentially form each of the layers of the object 11 while the powder bed 26 and the object 11 are being moved. The energy system 22 can selectively heat the powder 12 at least based on a data regarding to the object 11 to be built. The data may be corresponding to a computer-aided design (CAD) model data. The number of the energy systems 22 may be one or plural.

In one embodiment, the energy system 22 is positioned along an energy axis (direction) 22B and is arranged between the pre-heat device 16 and the powder supply assembly 18. The design of the energy system 22 can be varied. In one embodiment, the energy system 22 may include one or more energy source(s) 22C (“irradiation systems”) that direct one or more irradiation (energy) beam(s) 22D at the powder 12. The one or more energy sources 22C can be controlled to steer the energy beam(s) 22D to melt the powder 12.

As alternative, non-exclusives examples, each of the energy sources 22C can be designed to include one or more of the following: (i) an electron beam generator that generates a charged particle electron beam; (ii) an irradiation system that generates an irradiation beam; (iii) an infrared laser that generates an infrared beam; (iv) a mercury lamp; (v) a thermal radiation system; (vi) a visual wavelength system; (vii) a microwave wavelength system; or (viii) an ion beam system.

Different powders 12 have different melting points. As non-exclusive examples, the desired melting temperature may be at least 1000, 1400, 1700, 2000, or more degrees Celsius.

The control system 24 controls the components of the processing machine 10 to build the three-dimensional object 11 from the computer-aided design (CAD) model by successively melting portions of one or more of the powder layers 13. For example, the control system 24 can control (i) the powder bed assembly 14; (ii) the pre-heat device 16; (iii) the powder supply assembly 18; (iii) the measurement device 20; and (iv) the energy system 22. The control system 24 can be a centralized system or a distributed system.

The control system 24 may include, for example, a CPU (Central Processing Unit) 24A, a GPU (Graphics Processing Unit) 24B, and electronic memory 24C. The control system 24 functions as a device that controls the operation of the processing machine 10 by the CPU executing the computer program. This computer program is a computer program for causing the control system 24 (for example, a CPU) to perform an operation to be described later to be performed by the control system 24 (that is, to execute it). That is, this computer program is a computer program for making the control system 24 function so that the processing machine 10 will perform the operation to be described later. A computer program executed by the CPU may be recorded in a memory (that is, a recording medium) included in the control system 24, or an arbitrary storage medium built in the control system 24 or externally attachable to the control system 24, for example, a hard disk or a semiconductor memory. Alternatively, the CPU may download a computer program to be executed from a device external to the control system 24 via the network interface. Further, the control system 24 may not be disposed inside the processing machine 10, and may be arranged as a server or the like outside the processing machine 10, for example. In this case, the control system 24 and the processing machine 10 may be connected via a communication line such as a wired communications line (cable communications), a wireless communications line, or a network. In case of physically connecting with wired, it is possible to use serial connection or parallel connection of IEEE1394, RS-232x, RS-422, RS-423, RS-485, USB, etc. or 10BASE-T, 100BASE-TX, 1000BASE- T or the like via a network. Further, when connecting using radio, radio waves such as IEEE 802.1x, OFDM, or the like, radio waves such as Bluetooth (registered trademark), infrared rays, optical communication, and the like may be used. In this case, the control system 24 and the processing machine 10 may be configured to be able to transmit and receive various types of information via a communication line or a network. Further, the control system 24 may be capable of transmitting information such as commands and control parameters to the processing machine 10 via the communication line and the network. The processing machine 10 may include a receiving device (receiver) that receives information such as commands and control parameters from the control system 24 via the communication line or the network. As a recording medium for recording the computer program executed by the CPU, a CD-ROM, a CD-R, a CD-RW, a flexible disk, an MO, a DVD-ROM, a DVD-RAM, a DVD-R, a DVD+R, a DVD-RW, a magnetic medium such as a magnetic disk and a magnetic tape such as DVD+RW and Blu-ray (registered trademark), a semiconductor memory such as an optical disk, a magneto-optical disk, a USB memory, or the like, and a medium capable of storing other programs. In addition to the program stored in the recording medium and distributed, the program includes a form distributed by downloading through a network line such as the Internet. Further, the recording medium includes a device capable of recording a program, for example, a general-purpose or dedicated device mounted in a state in which the program can be executed in the form of software, firmware or the like. Furthermore, each processing and function included in the program may be executed by program software that can be executed by a computer, or processing of each part may be executed by hardware such as a predetermined gate array (FPGA, ASIC) or program software, and a partial hardware module that realizes a part of hardware elements may be implemented in a mixed form.

It should also be noted that with the unique designs provided herein, multiple operations may be performed at the same time (simultaneously) to improve the throughput of the processing machine 10. Stated in another fashion, one or more of (i) pre-heating with the pre-heat device 16, (ii) measuring with the measurement device 20, (iii) depositing powder 12 with the powder supply assembly 18, and (iv) melting the powder with the energy system 22 may be partly or fully overlapping in time on different parts of the powder bed 26 to improve the throughput of the processing machine 10. For example, two, three, four, or all five of these functions may be partly or fully overlapping.

In certain implementations, the build platform 26A may be moved down with the platform mover 26D along the rotation axis 25A in a continuous rate. With this design, a height 29 between the most recent (top) powder layer 13 and the powder supply assembly 18 (and other components) may be maintained substantially constant for the entire process. Alternatively, the powder bed 26 may be moved down in a step down fashion at each rotation, which could lead to the possibility of a discontinuity at one radial position in the powder bed 26. As used herein, “substantially constant” shall mean the height 29 varies by less than a factor of three, since the typical thickness of each powder layer is less than one millimeter. In another embodiment, “substantially constant” shall mean the height 29 varies less than ten percent of the height 29 during the manufacturing process.

As alternative implementations, (i) the build platform 26A can be moved in a linear fashion; (ii) the build platform 26A can be moved in a multiple axis fashion; (iii) the build platform 26A can be moved both linearly and rotationally; or (iv) the build platform 26A can be stationary.

In one implementation, only the powder bed 26 is primarily moved, while everything else (pre-heat device 16, powder supply assembly 18, measurement device 20, energy system 22) are all fixed, making the overall system simpler. Also, the throughput of a rotary based powder bed 26 system is much higher since one or more steps can be performed in parallel rather than serially.

Additionally, or alternatively, the processing machine 10 can include a component housing 30 that retains the pre-heat device 16, the powder depositor 18, the measurement device 20, and the energy system 22. Collectively these components may be referred to as the top assembly. Further, the processing machine 10 can include a housing mover 32 that can be controlled to selectively move the top assembly. The housing mover 32 and/or the device mover 28 can include one or more actuators (e.g. linear or rotary). The housing mover 32 and/or the device mover 28 may be referred to as a first mover or a second mover.

It should be noted that processing machine 10 can be designed to have one or more of the following features: (i) one or more of the pre-heat device 16, the powder supply assembly 18, the measurement device 20, and the energy system 22 can be selectively moved relative to the component housing 30 and/or the powder bed 26 in one or more of the six degrees of freedom; (ii) the component housing 30 with one or more of the pre-heat device 16, the powder supply assembly 18, the measurement device 20, and the energy system 22 can be selectively moved relative to the powder bed 26 in one or more of the six degrees of freedom; and/or (iii) the powder bed 26 can be selectively moved relative to the component housing 30 in one or more of the six degrees of freedom.

In a specific, alternative implementation, the housing mover 32 can move the top assembly (or a portion thereof) upward (e.g. along and/or transverse to the rotation axis 25A) relative to the powder bed 26 at a continuous (or stepped) rate while the powder 12 is being deposited to maintain the desired height 29.

Additionally, or alternatively, the housing mover 32 can rotate the top assembly (or a portion thereof) relative to the powder bed 26 about the rotation axis 25A relative to the powder bed 26 during the printing of the object 11. In this implementation, the powder bed 26 can be stationary, rotated about the rotation axis in the clockwise direction, rotated about the rotation axis in the counterclockwise direction, and/or or moved linearly along and/or transverse to the rotation axis 25A.

Stated in another fashion, the processing machine 10 illustrated in FIGS. 1A and 1 B may be designed so that (i) the powder bed 26 is rotated about the Z axis and moved along the rotation axis 25A; or (ii) the powder bed 26 is rotated about the rotation axis 25A, and the component housing 30 and the top assembly are moved along the rotation axis 25A only to maintain the desired height 29. In certain embodiments, it may make sense to assign movement along the rotation axis 25A to one component and rotation about the rotation axis 25A to the other.

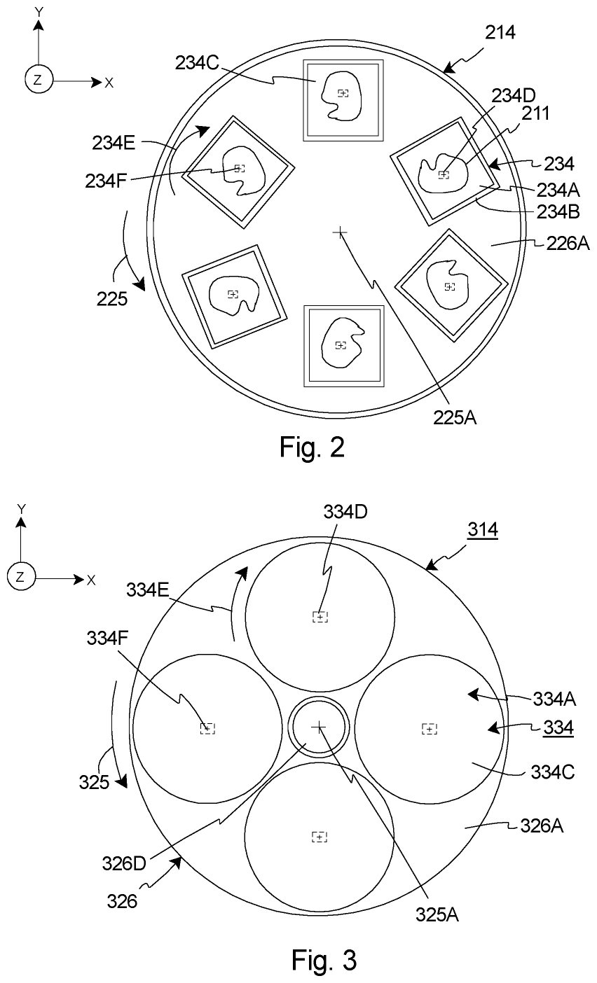

FIG. 2 is a simplified top illustration of another implementation of the powder bed assembly 214 that can be used in any of the processing machines 10 disclosed herein. In this embodiment, the powder bed assembly 214 can be used to make multiple objects 211 substantially simultaneously. The number of objects 211 that may be made concurrently can vary according the type of object 211 and the design of the processing machine 10. In FIG. 2, six objects 211 are made simultaneously. Alternatively, more than six or fewer than six objects 211 may be made simultaneously.

In FIG. 2, each of the objects 211 is the same design. Alternatively, for example, the processing machine 10 may be controlled so that one or more different types of objects 211 are made simultaneously.

In FIG. 2, the powder bed assembly 214 includes a relatively large support platform 226A, and a plurality of separate, spaced apart, build assemblies 234 that are positioned on and supported by the support platform 226A. The number of separate build assemblies 234 can be varied. In FIG. 2, the powder bed assembly 214 includes six separate build assemblies 214, one for each object 211. With this design, a single object 211 is made in each build assembly 234. Alternatively, more than one object 211 may be built in each build assembly 234. Still alternatively, the powder bed assembly 214 can include more than six or fewer than six separate build assemblies 234.

In one, non-exclusive embodiment, the support platform 226A with the build assemblies 234 can be rotated like a turntable during printing of the objects 211 in a moving direction 225 about a support rotation axis 225A (illustrated with a “+”, e.g. the Z axis). With this design, each build assembly 234 is rotated about at least one axis 225A during the build process. Further, in this embodiment, the separate build assemblies 234 are spaced apart on the large common support platform 226A. The build assemblies 234 can be positioned on or embedded into the support platform 226A. As non-exclusive examples, the support platform 226A can be disk shaped or rectangular shaped.

As provided herein, each of the build assemblies 234 defines a separate, discrete build region. For example, each build assembly 234 can include a build platform 234A, and a sidewall assembly 234B. In one embodiment, each build assembly 234 is an open container in which the object 211 can be built. In this design, after the object 211 is printed, the build assembly 234 with the printed object 211 can be removed from the support platform 226A via a robotic arm (not shown in FIG. 2) and replaced with an empty build assembly 234 for subsequent fabrication of the next object 211.

As non-exclusive examples, each build platform 234A can define a build area 234C that is rectangular, circular, or polygonal shaped.

In an alternative embodiment, one or more of the build platforms 234A can be moved somewhat like an elevator vertically (along the Z axis) relative to its side wall assembly 234B with a platform mover assembly 234D (illustrated in phantom with a box) during fabrication of the objects 211. Each platform mover assembly 234D can include one or more actuators. Fabrication can begin with the build platform 234A placed near the top of the side wall assembly 234B. The powder supply assembly (not shown in FIG. 2) deposits a thin layer of powder into each build assembly 234 as it is moved (e.g. rotated) below the powder supply assembly. At an appropriate time, the build platform 234A in each build assembly 234 is stepped down by one layer thickness so the next layer of powder may be distributed properly.

In some embodiments, one or more platform mover assemblies 234D can also or alternatively be used to move (e.g. rotate) one or more of the build assemblies 234 relative to the support platform 226A and each other in a platform direction 234E about a platform rotation axis 234F (illustrated with a “+”, e.g. the Z axis). With this design, each build platform 234A can be rotated about two, separate, spaced apart and parallel axes 225A, 234F during the build process.

In one, non-exclusive example, the support platform 226A can be rotated (e.g., at a substantially constant rate) in the moving direction 225 (e.g. counterclockwise), and one or more of the build assemblies 234 can be moved (e.g. rotated) relative to the support platform 226A in the opposite direction 234E (e.g. clockwise) during the printing process. In this example, the rotational speed of the support platform 226A about the support rotational axis 225A can be approximately the same or different from the rotational speed of each build assembly 234 relative to the support platform 226A about the platform rotational axis 234F.

Alternatively, the support platform 226A can be rotated (e.g., at a substantially constant rate) in the moving direction 225 (e.g. counterclockwise), and one or more of the build assemblies 234 can be moved (e.g. rotated) relative to the support platform 226A in the same direction 234E (e.g. counterclockwise) during the printing process.

FIG. 3 is a simplified top illustration of another implementation of a powder bed assembly 314 that can be used in any of the processing machines 10 disclosed herein. In this implementation, the powder bed assembly 314 can be used to make multiple objects (not shown in FIG. 3) substantially simultaneously.

In FIG. 3, the powder bed assembly 314 includes a relatively large support platform 326A, and a plurality of separate, spaced apart, build assemblies 334 that are integrated into the support platform 326A. The number of separate build assemblies 334 can be varied. In FIG. 3, the powder bed assembly 314 includes four separate build assemblies 334. With this design, one or more objects can be made on each build assembly 334. Alternatively, the powder bed assembly 314 can include more than four or fewer than four separate build assemblies 334.

In FIG. 3, each build assembly 334 defines a separate build platform 334A that is selectively lowered like an elevator with a platform mover assembly 334D (illustrated in phantom with a box) into the support platform 326A during the manufacturing process. With this design, the support platform 326A can define the support side wall for each build platform 334A. Fabrication can begin with the build platform 334A placed near the top of the support platform 326A. The powder supply assembly (not shown in FIG. 3) deposits a thin layer of powder onto each build platform 334A as it is moved (e.g. rotated) below the powder supply assembly. At an appropriate time, each build platform 334A is stepped down by one layer thickness so the next layer of powder may be distributed properly. Alternatively, each build platform 334A can be moved in steps that are smaller than the powder layer or moved in a continuous fashion, rather than in discrete steps.

In this Figure, each build platform 334A defines a circular shaped build area 334C that receives the powder (not shown in FIG. 3). Alternatively, for example, each build area 334C can have a different configuration, e.g. rectangular or polygonal shaped.

Additionally, the support platform 326A can be annular shaped and powder bed 326 can include a central, support hub 326D. In this implementation, there can be relative movement (e.g. rotation) between the support platform 326A and the support hub 326D. As a result thereof, one or more of the other components (e.g. the powder supply assembly) of the processing machine (not shown in FIG. 3) can be coupled to the support hub 326D.

In one, non-exclusive embodiment, the support platform 326A with the build assemblies 334 can be rotated like a turntable during printing of the objects in a moving direction 325 about the support rotation axis 325A (illustrated with a “+”) relative to the support hub 326D. With this design, each build platform 334A is rotated about at least one axis 325A during the build process.

In some embodiments, one or more platform mover assemblies 334D can be used to move (e.g. rotate) one or more of the build assemblies 334 relative to the support platform 326A and each other in a platform direction 334E about a platform rotational axis 334F (illustrated with a “+”, e.g. along the Z axis). With this design, each build platform 334A can be rotated about two, separate, spaced apart and parallel axes 325A, 334F during the build process.

In one, non-exclusive example, the support platform 326A can be rotated (e.g., at a substantially constant rate) in the moving direction 325 (e.g. counterclockwise), and one or more of the build assemblies 334 can be moved (e.g. rotated) relative to the support platform 326A in the opposite, platform direction 334E (e.g. clockwise) during the printing process. In this example, the rotational speed of the support platform 326A about the support rotational axis 325A can be approximately the same or different from the rotational speed of each build assembly 334 relative to the support platform 326A about the platform rotational axis 434F.

Alternatively, the support platform 326A and one or more of the build assemblies 334 can be rotated in the same rotational direction during the three dimensional printing operation.

It should be noted that in FIGS. 2 and 3, a separate platform mover assembly 234D, 334D is used for each build assembly 234, 334. Alternatively, one or more of the platform mover assemblies 234D, 334D can be designed to concurrently move more than one build assembly 234,334.

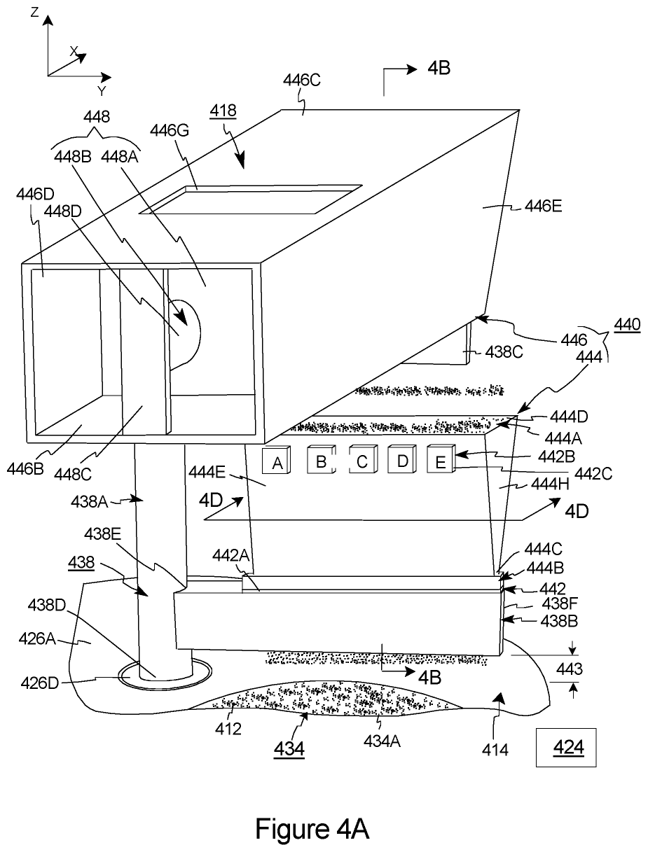

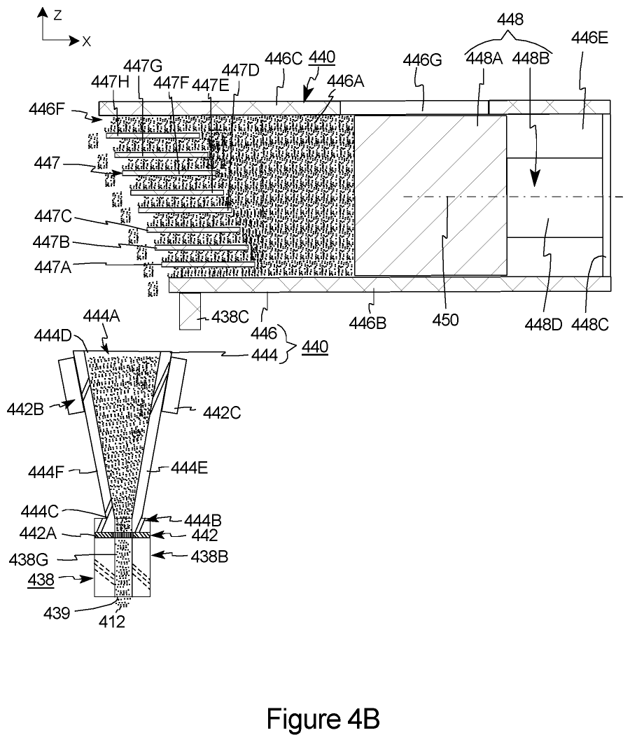

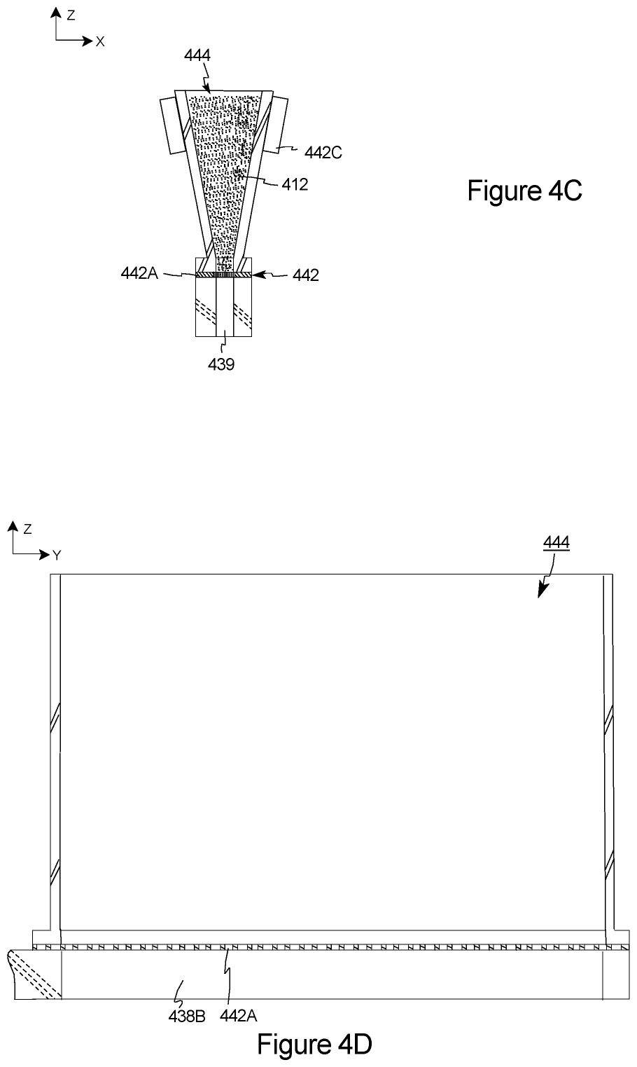

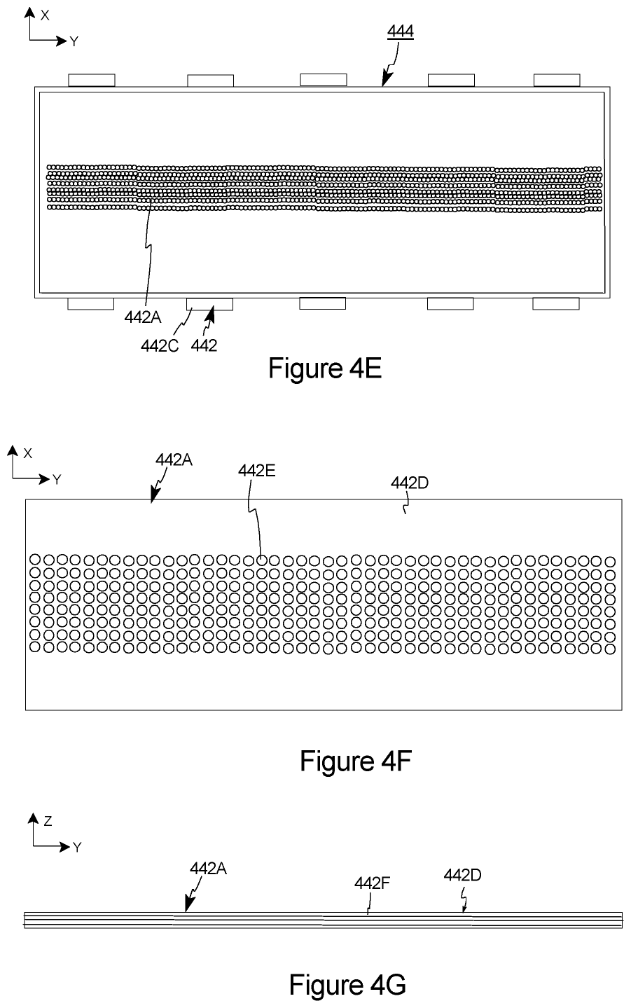

FIG. 4A is a perspective view of a portion of a powder bed assembly 414 including at least one build platform 434A, and a powder supply assembly 418 that can be integrated into the processing machine 10 described above. For example, the powder bed assembly 414 and the powder supply assembly 418 can be designed to have one or more the following movement characteristics while powder 412 is being deposited on the build platform 434A: (i) the build platform 434A is stationary; (ii) the build platform 434A is moved relative to the powder supply assembly 418; (iii) the build platform 434A is moved linearly (along one or more axes) relative to the powder supply assembly 418; (iv) the build platform 434A is rotated (about one or more axes) relative to the powder supply assembly 418; (v) the powder supply assembly 418 is stationary; (vi) the powder supply assembly 418 is moved relative to the build platform 434A; (vii) the powder supply assembly 418 is moved linearly (along one or more axes) relative to the build platform 434A; and/or (viii) the powder supply assembly 418 is rotated (about one or more axes) relative to the build platform 434A. These can be collectively referred to as “Movement Characteristics (i)-(viii)”.

It should be noted that the powder bed assembly 414 and the powder supply assembly 418 can be designed to have any combination of the Movement Characteristics (i)-(viii). Further, the build platform 434A can be circular, rectangular or other suitable shape.

In the implementation illustrated in FIG. 4A, the powder bed assembly 414 is somewhat similar to the implementation illustrated in FIG. 3, and includes a relatively large support platform 426A, a central support hub 426D, and a plurality of separate, spaced apart, build assemblies 434 (only one is illustrated) that are integrated into the support platform 426A. With this design, the support platform 426A with the build assemblies 434 can rotate relative to the support hub 426D, and/or the build assemblies 434 can rotate relative to the support platform 426A.

Further, in FIG. 4A, the powder supply assembly 418 is secured to the support hub 426D, and cantilevers and extends radially over the support platform 426A to selectively deposit the powder 412 (illustrated with small circles) onto the moving build assemblies 434. Alternatively, or additionally, the powder supply assembly 418 could be designed to be moved (e.g. linearly or rotationally) relative to the build assemblies 434. Still alternatively, the powder supply assembly 418 can be retained in another fashion than via the support hub 426D. For example, the powder supply assembly 418 can be coupled to the upper component housing 30 (illustrated in FIG. 1A).

In FIG. 4A, the powder supply assembly 418 is a top-down, gravity driven system that is shown with a circular shaped build platform 434A.

FIG. 4B is a cut-away view of the powder supply assembly 418 taken on line 4B-4B in FIG. 4A.

With reference to FIGS. 4A and 4B, in one implementation, the powder supply assembly 418 includes a supply frame assembly 438, a powder container assembly 440, and a flow control assembly 442 that is controlled by the control system 424 to selectively and accurately deposit the powder 412 onto the build platform(s) 434A. The design of each of these components can be varied to suit the design requirements of the processing machine 10. In FIGS. 4A and 4B, the flow control assembly 442 is illustrated as being recently activated and the powder supply assembly 418 is releasing the powder 412 towards the build platform 434A.

The supply frame assembly 438 supports and couples the powder container assembly 440 and the flow control assembly 442 to the rest of the processing machine 10. The supply frame assembly 438 can fixedly couple these components to the support hub 426D. In one, non-exclusive implementation, the supply frame assembly 438 includes (i) a riser frame 438A that is fixedly coupled to and extends upwardly along the Z axis from the support hub 426D; (ii) a lower transverse frame 438B that is fixedly coupled to and cantilevers radially away from the riser frame 438A; and (iii) an upper transverse frame 438C that is fixedly coupled to and cantilevers radially away from the riser frame 438 spaced apart from the lower transverse frame 438B. It should be noted that any of the frames 438A, 438B, 438C can be referred to as a first frame, a second frame or a third frame.

The riser frame 438A is rigid and includes (i) a riser proximal end 438D that is secured to the support hub 426D, and (ii) a riser distal end (not shown) that is positioned above the support hub 426D. Further, the lower transverse frame 438B is rigid and includes (i) a transverse proximal end 438E that is secured to the riser frame 438A, and (ii) a transverse distal end 438F that extends over an outer perimeter of the build platform 434A. Moreover, the upper transverse frame 438C is rigid and includes (i) a transverse proximal end that is secured to the riser frame 438A, and (ii) a transverse distal end that extends over the build platform 434A. In one, non-exclusive implementation, the riser frame 438A is right cylindrical shaped (e.g. hollow or solid), and each transverse frame 438B, 438C is rectangular beam shaped. However, other shapes and configurations can be utilized.

Additionally, the lower transverse frame 438B can include a frame passageway 438G that allows the powder 412 from the flow control assembly 442 to flow therethrough. For example, the frame passageway 438G can be rectangular shaped. Further, the frame passageway 438G can define the supply outlet 439 of the powder 412 from the powder supply assembly 418. The supply outlet 439 receives the powder 412 from the powder container assembly 440 and the flow control assembly 442.

In one embodiment, the supply outlet 439 is positioned above and spaced apart a separation distance 443 from the build platform(s) 434A or uppermost powder layer on the build platform 434A. The size of the separation distance 443 can vary depending on the environment around the powder supply assembly 418. For example, the separation distance 443 can be larger if operated in a vacuum environment. As a non-exclusive embodiment, the separation distance 443 can be as small as the largest powder particle size. As a non-exclusive example, the separation distance 443 can be between approximately zero to fifty millimeters.

Alternatively, the powder supply assembly 418 can be designed so that the supply outlet 439 is directly adjacent to and/or against the build platform(s) 434A or uppermost powder layer on the build platform 434A.

The powder container assembly 440 retains the powder 412 that is being deposited onto the build platform(s) 434A. In the non-exclusive implementation of FIGS. 4A and 4B, the powder container assembly 440 includes (i) a first container subassembly 444 that retains and deposits the powder 412 onto the build platform(s) 434A; (ii) a second container subassembly 446 that retains and deposits powder 412 into the first container subassembly 444 to refill the first container subassembly 444; and (iii) an actuator system 448 that urges powder 416 from the second container subassembly 446 to fill the first container subassembly 444. The design of these components can be varied pursuant to the teachings provided herein.

As an overview, in this design, the powder container assembly 440 is a multiple stage powder delivery system that includes (i) the first container subassembly 444 (“fine stage” or “fine powder supply”) that accurately deposits the powder 412 onto the build platform(s) 434A; and (ii) the second container subassembly 446 (“coarse stage” or “coarse powder supply”) that selectively refills the first container subassembly 444. The second container subassembly 446 can retain the majority of the powder, while the first container subassembly 444 retains a smaller amount of powder mass which allows for the first container subassembly 444 to accurately control the amount of powder 412 that is added onto the build platform(s) 434A.

In the non-exclusive implementation of FIG. 4A, (i) the first container subassembly 444 is positioned above, coupled to, and supported by the lower transverse frame 438B of the supply frame assembly 438; and (ii) the second container subassembly 446 is positioned above the first container subassembly 444, and the second container subassembly 446 is coupled to and supported by the upper transverse frame 438C of the supply frame assembly 438. However, each container subassembly 444, 446 can be retained in a different fashion.

In one nonexclusive implementation, the first container subassembly 444 defines a first container region 444A that retains the powder 412 prior to distribution onto the build platform 434A, and that is open at the top and the bottom. The first container subassembly 444 can include a container base 444B that couples the first container subassembly 444 to the transverse frame 438B with the flow control assembly 442 positioned therebetween. For example, the first container region 444A and the container base 444B can be integrally formed or secured together during assembly. In this implementation, the opening at the top of the first container region 444A is larger than the opening at its bottom. Further, in this implementation, the first container region 444A is oriented substantially perpendicular to the build platform(s) 434A and is aligned with gravity.

The size and shape of the first container region 444A can be varied to suit the powder 412 supply requirements for the system. In one non-exclusive implementation, the first container region 444A is tapered, rectangular tube shaped (V shaped cross-section) and includes (i) a bottom, container proximal end 444C (“open bottom”) that is coupled to the container base 444B, and that is an open, rectangular shape; (ii) a top, container distal end 444D (“open top”) that is an open, rectangular tube shaped and positioned above the proximal end 444C; (iii) a front side 444E; (iv) a back side 444F; (v) a left side 444G (illustrated in FIG. 4D); and (vi) a right side 444H. Any of these sides can be referred to as a first, second, third, etc side. The first container region 444A can function as a funnel that uses gravity to urge the powder 412 against the flow control assembly 442.

In one design, the left side 444G and the right side 444H extend substantially parallel to each other; while the front side 444E and a back side 444F taper towards each other moving from the container distal end 444D to the container proximal end 444C. The sides 444E, 444F can be steep (near vertical). As non-exclusive examples, the angle of taper relative to normal (vertical) can be at approximately 0, 0.5, 1, 2, 4, 6, 8, 10, 20, 30 degrees or other angles. The angle of taper can be determined based upon the characteristics (e.g. size) of the powder particles, the material of the powder particles, the amount of powder to be retained in the first container region 444A and other factors. In certain implementations, the first container region 444A comprises two slopes (walls 444E, 444F) getting closer to each other from one end (top 444D) to the other end (bottom 444C) on which the flow controller 442A is provided. Stated in another fashion, the first container region 444A comprises two walls 444E, 444F that slope towards each other from a first end 444D to the second end 444C in which the flow controller 442C is located. An angle between two slopes of the walls 444E, 444F can be determined based upon a type of powder 412.

It should be noted that other shapes and configurations of the first container region 444A can be utilized. For example, the first container region 444A can have a tapering, oval tube shape, or another suitable shape.

The container base 440B can be rectangular tube shaped to allow the powder 412 to flow therethrough.

The control system 424 controls the flow control assembly 442 to selectively and accurately control the flow of the powder 412 from the supply outlet 439 onto the build platform(s) 434A. In one implementation, the flow control assembly 442 includes a flow controller 442A and an activation system 442B. In this implementation, (i) the flow controller 442A can be a flow restrictor such as one or more mesh screen(s) or other porous structure; and (ii) the activation system 442B can include one or more vibration generators 442C that are controlled by the control system 424 to selectively vibrate the first container subassembly 444. Each vibration generator 442C can be a vibration motor.

As provided herein, the plurality of vibration generators 442C are provided on two walls 444E, 444F. Further, in certain implementations, the flow controller 442A is elongated a first direction (e.g. along the Y axis) that crosses the build platform 434A, and the plurality of vibration generators 442C are provided on the walls 444E, 444F along the first direction.

With this design, sufficient vibration of the first container region 444A by the vibration generator(s) 442C causes the powder 412 to flow through the flow controller 442A to the build platform(s) 434A. In contrast, if there is insufficient vibration of the first container region 444A by the vibration generator(s) 442C, there is no flow through the flow controller 442A. Stated in another fashion, the amplitude and frequency of vibration by the vibration generator(s) 442C can control the flow rate of the powder 412 through the flow controller 442A to the build platform(s) 434A. Generally speaking, no vibration results in no flow of the powder 412, while the flow rate of the powder 412 increases as vibration increases. Thus, the vibration generator(s) 442C can be controlled to precisely control the flow rate of powder 412 to the build platform(s) 434A.

The location of the flow controller 442A can be varied. In FIGS. 4A and 4B, the flow controller 442A is located between the first container region 444A and the transverse frame 438B. Alternatively, for example, the flow controller 442A can be located below the transverse frame 438B near the supply outlet 439.

The number and location of the vibration generator(s) 442C can be varied. In the non-exclusive implementation in FIGS. 4A and 4B, the activation system 442B includes (i) five spaced apart vibration generators 442C that are secured to the front side 444E near the top, container distal end 444D; and (ii) five spaced apart vibration generators 442C (only one is visible in FIG. 4B) that are secured to the back side 444F near the container distal end 444D. These vibration generators 442C are located above the flow controller 442A to vibrate the powder 412 in the first container region 444A. Alternatively, the activation system 442B can include more than ten or fewer than ten vibration generators 442C, and/or one or more of the vibration generators 434A located at different positions than illustrated in FIGS. 4A and 4B.

The five vibration generators 442C on each side 444E, 444F can be spaced apart linearly moving left to right. In FIG. 4A, the individual vibration generators 442C on the front side 444E are labeled A-E moving left to right linearly for ease of discussion. With this design, the vibration generators 442C can be independently controlled to control the distribution rate of the powder 412 moving linearly along the power supply assembly 418. This allows for control of the powder distribution radially from near the center to near the edge of the powder bed assembly 414. For example, if more powder 412 is needed near the edge than the center, the vibration generators 442C labelled “D” and “E” can be activated more than the vibration generators 442C labelled “A” and “B”.

With the present design, when it is desired to deposit the powder 412 onto the build platform 434A, the vibration generator(s) 442C is (are) turned ON to start the vibration motion. At this time, the powder 412 will pass from the powder container 440A through the flow controller 442A to deposit the powder 412. In contrast, when it is desired to stop the deposit of the powder 412, the vibration generators 442C are OFF, and the powder 412 will remain inside the powder container 440A.

With the present design, a thin, accurate, even layer of powder 412 can be supplied to the build platform(s) 434A without having to spread the powder 412 (e.g. with a rake) using the top-down vibration activated, powder supply assembly 418 disclosed herein. This powder supply assembly 418 is cost-effective, simple, and reliable method for delivering powder 412. Further, it requires a minimal amount of hardware to achieve even powder layers 412 on the build platform(s) 434A.

It should be noted that another type of flow controller 442A can be utilized to control the flow of powder 412 from the first container region 444A.

The second container subassembly 446 is positioned above the first container subassembly 444 and is used to refill and resupply the first container subassembly 444. In one implementation, the second container subassembly 446 defines a second container region 446A that retains the powder 412 prior to refilling the first container subassembly 444.

The size and shape of the second container region 446A can be varied to suit the powder 412 supply requirements for the system. In one non-exclusive implementation, the second container region 446A is generally rectangular tube shaped, and includes (i) a rectangular shaped bottom wall 446B, (ii) a rectangular shaped top wall 446C that is spaced apart from the bottom wall 446B, (iii) a rectangular shaped left side wall 446D that extends between the bottom wall 446B and the top wall 446C; and (iv) a rectangular shaped right side wall 446E that extends between the bottom wall 446B and the top wall 446C. Any of these walls 446B-446E can be referred to as a first, second, third, etc., wall.

The walls 446B-446E can cooperate to define a refill outlet 446F that is positioned over the open first container region 444A. In this implementation, the actuator system 448 urges the powder 412 from the second container region 446A out the refill outlet 445A, and the powder 412 falls via gravity into the first container region 444A. As illustrated in FIG. 4B, the refill outlet 446F can be a rectangular shaped opening.

Additionally, the second container subassembly 446 can include one or more fins 447 that are positioned in the refill outlet 446F and that extend between the side walls 446D, 446E. For example, the second container subassembly 446 can include a plurality of spaced apart fins 447 (i) that extend transversely across the refill outlet 446F, (ii) that are spaced apart between bottom wall 446B and the top wall 446C; and (iii) that each extend substantially parallel to the bottom wall 446B, the top wall 446C, and the build platform(s) 434A. Further, each successive fin 447 moving from the bottom wall 446B to the top wall 446C can extend farther over the first container subassembly 444.

The number of fins 447 utilized can be varied pursuant to the teachings provided herein. In the non-exclusive implementation of FIG. 4B, the second container subassembly 446 includes eight spaced apart fins 447. Alternatively, the second container subassembly 446 can include more than or fewer than eight spaced apart fins 447. In FIG. 4B, moving from the bottom to the top, the fins 447 can be labeled as a first fin 447A, a second fin 447B, a third fin 447C, a fourth fin 447D, a fifth fin 447E, a sixth fin 447F, a seventh fin 447G, and an eighth fin 447H. In this implementation, (i) the first fin 447A extends farther over the first container subassembly 444 than the bottom wall 446B; (ii) the second fin 447B extends farther over the first container subassembly 444 than the first fin 447A; (iii) the third fin 447C extends farther over the first container subassembly 444 than the second fin 447B; (iv) the fourth fin 447D extends farther over the first container subassembly 444 than the third fin 447C; (v) the fifth fin 447E extends farther over the first container subassembly 444 than the fourth fin 447D; (vi) the sixth fin 447F extends farther over the first container subassembly 444 than the fifth fin 447E; (vii) the seventh fin 447G extends farther over the first container subassembly 444 than the sixth fin 447F; and (viii) the eighth fin 447H extends farther over the first container subassembly 444 than the seventh fin 447G.

With this design, when the actuator system 448 urges the powder 412 from the second container region 446A out the refill outlet 446F, the fins 447 will cause the falling powder 412 to be distributed transversely along the X axis into the first container subassembly 444. This allows the first container subassembly 444 to be filled more accurately, and subsequently allows the first container subassembly 444 to distribute the powder 412 more accurately onto the build platform(s) 434A.

Additionally, in certain implementations, the second container subassembly 446 includes an inlet 446G that allows the second container subassembly 446 to be refilled. For example, the inlet 446G can be an opening in the top wall 446C.

Additionally or alternatively, in certain implementations, to avoid the phenomena known as powder locking or jamming, the top wall 446A and the bottom wall 446B can be designed to not be equidistant everywhere (as shown), but are further apart near the fins 447 to maintain a constant or increasing powder flow area.

In one implementation, the second container region 446A is oriented substantially parallel to the build platform(s) 434A and substantially perpendicular to the first container region 444A. However, other orientations are possible. Further, the container subassemblies 444, 446 in FIGS. 4A and 4B are spaced apart. However, the container subassemblies 444, 446 can be designed to be interconnected in other designs.

The actuator system 448 urges the powder 412 from the second container region 446A out of the refill outlet 446F. In one implementation, the actuator system 448 includes a movable part 448A that is movable in the second container region 446A along a movement axis 450, and a part mover assembly 448B that selectively moves the movable part 448A in the second container region 446. In one non-exclusive example, (i) the movable part 448A can be rectangular box shaped and size to closely fit within the second container region 446, and (ii) the part mover assembly 448B can include a connector beam 448C that extends between the bottom wall 446B and the top wall 446C, and a motor 448D that extends between the connector beam 448C and the movable part 448A.

With this design, the motor 448D can be controlled with the control system 424 to selectively move the movable part 448A in the second container region 446A along the movement axis 450. For example, the motor 448D can move the movable structure 448A as necessary from right to left in FIG. 4B to urge the powder 412 from the second container region 446A to refill the first container region 444A. In FIGS. 4A and 4B, the powder 412 is being urged from the refill outlet 446F. Alternatively, the motor 448D can retract the movable structure 448A (moved from left to right) to allow for refilling of the second container region 446A via the inlet 446G.

In this implementation, the movable part 448A can be moved linearly sideways with the motor 448D (e.g. a linear motor, a fine pitch thread, or other actuator) somewhat similar to a piston relative to the second container region 446A and the walls act like as the piston's cylinder wall 446B-446E.

As illustrated in FIG. 4B, the plurality of fins 447 can be oriented substantially parallel to the movement axis 450. However, other orientations are possible.

Additionally, or alternatively, the powder supply assembly 418 can be used with a powder leveler (not shown) such as a rake, roller, wiper, squeegee, and/or a brush to further improve the flat powder surface.

FIG. 4C is a cut-away view of the first container subassembly 444 similar to FIG. 4B, except in FIG. 4C, the vibration generators 442C are turned off. At this state, no powder 412 is flowing through the flow controller 442A and out the supply outlet 439.

FIG. 4D is a cut-away view taken from line 4D-4D in FIG. 4A of the first container subassembly 444, without the powder. Basically, FIG. 4D illustrates the first container subassembly 444, the flow controller 442A, and a portion of the lower transverse frame 438B.

FIG. 4E is a simplified top view of the first container subassembly 444, without the powder; and the flow controller 442A and the vibration generators 442C of the flow control assembly 442.

FIG. 4F is a top view of one implementation of the flow controller 442A. In this implementation, the flow controller 442A includes a flow structure 442D, and a plurality of flow apertures 442E that extend through the flow structure 442D. In this embodiment, the flow structure 442D is rectangular plate shaped to correspond to the bottom container end 440C (illustrated in FIG. 4B). However, other shapes are possible.

The flow apertures 442E can have a circular, oval, square, polygonal, or other suitable shape. Further, flow apertures 442E can follow a straight or curved path through the flow structure 442D. Moreover, in this implementation, one or more (typically all) of the flow apertures 442E have an aperture size that is larger than a nominal particle size of the powder 412.

FIG. 4G is a side view the flow structure 442D of the flow controller 442A. In this implementation, the flow structure 442D includes one or more mesh screens 442F. In FIG. 4G, the flow structure 442D includes four mesh screens 442F. Alternatively, it can include more than four or fewer than four mesh screens 442F. In this design, the mesh screens 442F combine to define the plurality of spaced apart flow apertures 442E (illustrated in FIG. 4F).

With reference to FIGS. 4A-4G, in certain implementations, the sizes of flow apertures 442E, the vibration amplitude and/or the vibration directionality of the vibration generator(s) 442C may be adjusted to control the amount of the powder 412 supplied over the build platform 434A. The control system 424 may control the vibration generators 442C based on feedback results from the measurement device 20 (illustrated in FIG. 1A).

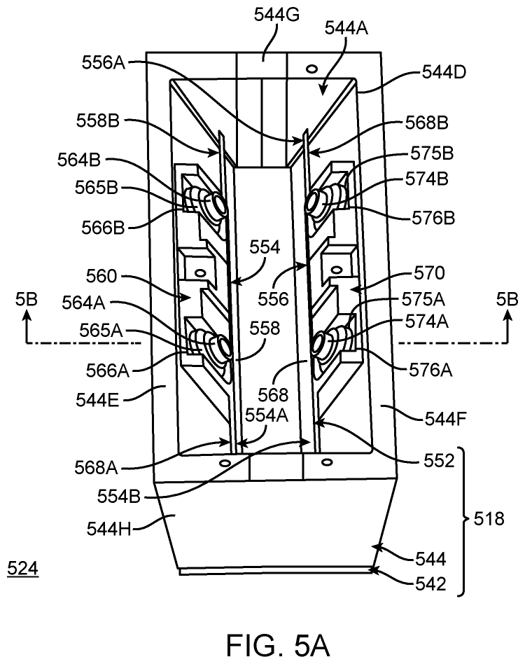

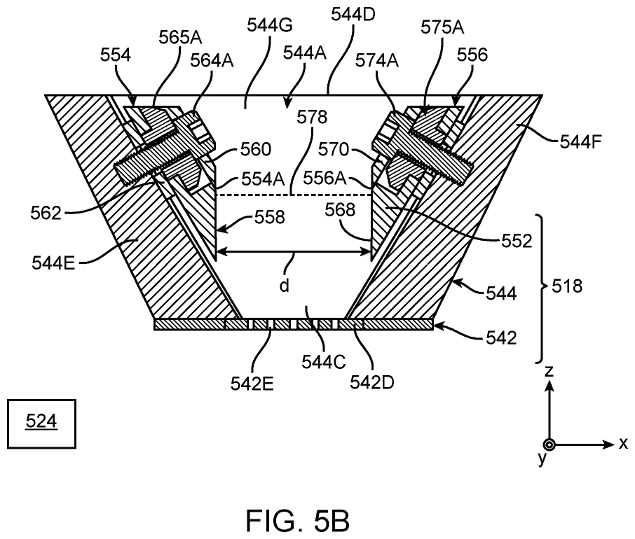

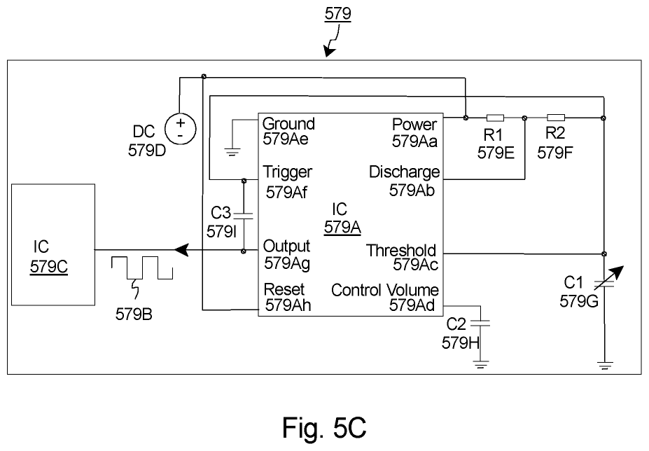

FIG. 5A is a top perspective view of another implementation of a powder supply assembly 518 including a flow control assembly 542 and a container assembly 544 that can be used to deliver powder 412 (illustrated in FIG. 4A) to any of the powder bed assemblies 14, 214, 314, 414 disclosed herein, or another type of bed assembly. In this implementation, the flow control assembly 542 and the container assembly 544 are somewhat similar to the corresponding components described above. However, as an overview, in this embodiment, the powder supply assembly 518 additionally includes a powder level sensor assembly 552 that monitors the level and/or amount of the powder 412 in the container assembly 544.

As a non-exclusive example, the container assembly 544 with the powder level sensor assembly 552 of FIG. 5A can be used as the first container subassembly 444 (illustrated in FIG. 4A) in a multiple stage powder supply assembly 418 (illustrated in FIG. 4A). Alternatively, for example, the container assembly 544 with the powder level sensor assembly 552 can be used in a single container, powder supply assembly, or as the second subassembly 446 (illustrated in FIG. 4A) in the multiple stage powder supply assembly 418 (illustrated in FIG. 4A).

FIG. 5B is a cross-sectional front elevation view of the powder supply assembly 518 including the flow control assembly 542, the container assembly 544, and the level sensor assembly 552 taken along line 5B-5B of FIG. 5A.

With reference to FIGS. 5A and 5B, in this design, the flow control assembly 542 again includes a flow structure 542D having flow apertures 542E that are similar to the corresponding components described above. The activation system is not illustrated in FIGS. 5A and 5B. One of the challenges of distributing powder 412 with this type of flow structure 542D is that the flow rate through the flow structure 542D can be sensitive to the level of powder 412 in the container assembly 544.

Further, in FIGS. 5A and 5B, in this non-exclusive implementation, the container assembly 544 defines a container region 544A that retains the powder 412 prior to distribution onto the build platform 434A (illustrated in FIG. 4A). In this implementation, the container region 544A is oriented substantially perpendicular to the build platform(s) 434A and is aligned with gravity. Further, the container assembly 544 is somewhat similar to the corresponding designs described above. However, as provided above, the container assembly 544 additionally includes the powder level sensor assembly 552 that constantly monitors the level of the powder 412 in the container region 544A.

The size, shape and design of the container assembly 544 can be varied to suit the powder 12 supply requirements for the system. In one non-exclusive implementation, the container assembly 544 is tapered, rectangular tube shaped, and has a truncated V shaped cross-section. In this design, the container assembly 544 includes (i) a bottom, container proximal end 544C (“bottom opening”), and that is an open, rectangular shape; (ii) a top, container distal end 544D (“top opening”) that is an open, rectangular shape and positioned above the proximal end 544C; (iii) a front side 544E; (iv) a back side 544F; (v) a left side 544G; and (vi) a right side 544H. It should be noted that the sides are referenced consistent with the container orientation in FIG. 4A. Further, it should be noted that any of these sides can be referred to as a first, second, third, etc., side.

In this, non-exclusive design, the top opening 544D is larger than the bottom opening 544C, and the container assembly 544 can function as a funnel that uses gravity to urge the powder 12 against the flow control assembly 542. In one design, the left side 544G and the right side 544H extend substantially parallel to each other; while the front side 544E and a back side 544F taper (slope) towards each other moving from the top opening 544D to the bottom opening 544C. The sides 544E, 544F can be steep (near vertical). As non-exclusive examples, the angle of taper relative to normal (vertical) can be at approximately 0, 0.5, 1, 2, 4, 6, 8, 10, 20, 30 degrees or other angles. The angle of taper (slopes of the walls 544E, 544F) can be determined based upon the characteristics (e.g. size) of the powder particles, the material of the powder particles, the amount of powder to be retained in the container region 544A and other factors.

It should be noted that other shapes and configurations of the container assembly 544 can be utilized. For example, the container assembly 544 can have a tapering, oval tube shape, or another suitable shape.

The design of the powder level sensor assembly 552 can be varied pursuant to the teachings provided herein. In the non-exclusive implementation of FIGS. 5A and 5B, the powder level sensor assembly 552 is configured to detect the presence and/or amount and/or height/level of powder 512 contained in the container assembly 544. In certain embodiments, the powder level sensor assembly 552 can include one or more capacitive sensors, such as parallel electrode capacitive sensors, configured to detect a change in capacitance correlating with the presence, absence, and/or height/level of powder in the container assembly 544. Alternatively, the powder level sensor assembly 552 can monitor or measure another physical or electrical quantity. For example, as described in more detail below, the powder level sensor assembly 552 can monitor a time required to reach a threshold voltage and/or monitoring a sinusoidal signal to monitor level or amount of powder 512.

In one example, the powder level sensor assembly 552 is coupled to and disposed within the volume of the container assembly 544. More particularly, the powder level sensor assembly 552 can comprise a first electrode member 554 (also referred to as a first electrode) coupled to the front side wall 544E, and a second electrode member 556 (also referred to as a second electrode) coupled to the back side wall 544F. The first electrode member 554 can be somewhat beam shaped and comprise an electrode portion 558 and a coupling or mounting portion 560. In this design, the electrode portion 558 can comprise extension portions 558A and 558B extending from opposite sides of the mounting portion 560. One or more insulator members 562 can be positioned between the mounting portion 560 and the front side wall 544E to electrically insulate/isolate the first electrode member 554 from the container assembly 544, and space the first electrode member 554 inwardly away from the front side wall 544E.

The first electrode member 554 can be coupled (or fixedly secured) to the container assembly 544 by one or a plurality of fasteners. For example, in the illustrated embodiment two fasteners 564A and 564B are disposed through respective grommets or insulative bushings 565A and 565B. The fasteners and bushings are positioned in respective recesses 566A and 566B defined in the mounting portion 560. In this design, the fasteners 564A, 564B extend (e.g. thread) into and engage the front side wall 544E. The bushings 565A, 565B can electrically insulate the first electrode member 554 from the fasteners 564A, 564B and from the container assembly 544.

The second electrode member 556 can be configured similarly to the first electrode member 554, and can comprise an electrode portion 568 and a mounting portion 570 coupled to the back side wall 544F by fasteners 574A and 574B. The fasteners can extend through respective insulative bushings 575A and 575B positioned in corresponding recesses 576A, 576B defined in the mounting portion 570. As shown, the second electrode member 558 can be spaced inwardly from the rear side wall 544F by one or more insulator members 572. Further, the second electrode member 556 can also comprise extension portions 568A, 568B extending from opposite sides of the mounting portion 570 parallel with the portions 558A, 558B of the first electrode member 554.

As provided herein, the electrode portion 558 (including the extension portions 558A and 558B) of the first electrode member 554 can define a first outer surface 554A that extends in the y-z plane of FIG. 5B. Similarly, the electrode portion 568 (including the extension portions 568A and 568B) of the second electrode member 556 can define a second outer surface 556A also extending in the y-z plane of FIG. 5B. The surfaces 554A and 556A can be in a parallel, or substantially parallel, opposed arrangement, and spaced apart by a specified distance d (also referred to herein as a gap). The surfaces 554A and 556A can also have the same or substantially the same area (e.g., ±5%). Accordingly, the electrode members 554 and 556 can form a parallel plate capacitor with a capacitance C given by the following equation, where k is the relative permittivity of the dielectric material between the electrode members, ε₀ is the permittivity of free space, A is the area of the surfaces 554A and 556A, and d is the distance/gap width between the surfaces 554A and 556A:

$$C = \frac{k {ε}_{0} A}{d} .$$

In certain embodiments, the area A can be the area of the surfaces 554A and 556A, or can be the total surface area of the portions of the electrodes oriented inwardly toward the interior of the container assembly.

The gap between the electrode members 554 and 556 can be configured to allow powder 412 to flow between the electrode members 554 and 556. In operation, the capacitance C between the first and second electrode members 554, 556 and/or their respective electrode portions 558, 568, can vary in accordance with the level of the powder in the container assembly 544. With this design, the control system 524 (illustrated as a box) can continuously monitor the capacitance C between the first and second electrode members 554, 556 to monitor the level and/or amount of the powder in the container assembly 544. With this design, the control system 524, for example, can monitor when it is necessary refill, and can control the refilling of the container assembly 544 (e.g. with a coarse powder supply) in a closed loop fashion.

In FIG. 5B, the powder level 578 is indicated schematically with a dashed line. For example, as the powder level 578 rises between the electrode portions 558, 568, the permittivity can increase, resulting in an increased capacitance C. Thus, using the permittivity k of the powder material, the capacitance C that is sensed/determined between the first and second electrode members 554, 556 can be correlated with the powder level 578 of the powder and/or with the quantity (e.g., volume) of powder in the container assembly 544.

In certain embodiments, the electrode members 554, 556 can be made from any suitable electrical conductor, such as metals including copper, steel, aluminum, etc. In certain embodiments, the insulator members 562, 572, and/or the insulative bushings 565A, 565B, 575A, 575B can comprise any suitable electrically insulative, heat resistant material, such as mica, any of various ceramic materials, glass (e.g., fiberglass), etc.

In certain embodiments, the electrode members 554, 556 can extend along 30%, 40%, 50%, 60%, 70%, 80%, 90%, or 100% of the length of the container assembly 544. In certain embodiments, the container assembly 544 can comprise a plurality of powder level sensor assemblies 552 positioned at different locations along the length, width, and/or height of the container assembly 544 to detect, for example, variation in the height of the powder at different locations in the container assembly 544.

The powder level sensor assembly 552 provided herein can be used in combination with any of the powder supply assemblies and/or additive manufacturing systems described herein.

As provided above, the control system 524 can continuously monitor the capacitance C between the first and second electrode members 554, 556 to monitor the level of the powder 412 in the container assembly 544. In one implementation, as an overview, the control system 524 measures very small changes (e.g. in the picoFarad range) in the capacitance of the level sensor assembly 552 based on measuring powder volume is solved by using a Field-Programmable Gate Array (FPGA) to measure the frequency of the oscillating output signal of a timer circuit that changes in frequency as the capacitance changes in the capacitive sensors.

As provided herein, (i) increasing the amount of dielectric powder 412 in the container region 544A increases the capacitance measured from the parallel electrode members 554, 556; and (ii) decreasing the amount of dielectric powder 412 in the container region 544A decreases the capacitance measured from the parallel electrode members 554, 556. Since the capacitance value changes as the volume of metal powder 412 changes, a capacitance sensing circuit 579 (illustrated in FIG. 5C) of the control system 524 can be used to determine if there has been a change in the volume of the powder 412 in the container assembly 544.

The absolute value of the capacitance can vary depending on the design of the container assembly 544 and the electrode members 554, 556. With reference to FIG. 5B, it can be seen that there are three possible capacitors that can influence the total value of the capacitance being measured. More specifically, (i) a first capacitor C_{A} can be formed between the first electrode member 554 and the front side 544E of the container assembly 544; (ii) a second capacitor C_{B} can be formed between the second electrode member 556 and the back side 544F of the container assembly 544; and (iii) a third capacitor Cs can be formed between the first electrode member 554 and the second electrode member 556.

The level of the powder 412 in the container assembly 544 can determine whether or not capacitors, C_{A} and C_{B}, would greatly influence the total capacitance. If the sides 544E, 544F of the container assembly 544 are made out of non-conductive material, then C_{A} and C_{B} can be ignored and thus the capacitance that is being measured is effectively C_{S} (the capacitance between the electrode members 554, 556). Alternatively, if the sides 544E, 544F of the container assembly 544 are made out of conductive material, and is grounded to the same ground as the capacitance sensing circuit 579, then the total capacitance that would be measured would be C_{A}+C_{B}+C_{S}. Additionally, if the gap between each of the electrodes 554, 556 to the respective sides 544E, 544F is much smaller than the gap between the two electrodes members 554, 556 themselves, C_{A} and C_{B} would then be greatly affecting the total capacitance that is being measured.

FIG. 5C is a simplified schematic view a non-exclusive capacitance sensing circuit 579 of the control system 524 (illustrated in FIGS. 5A and 5B) that can be used to monitor the capacitance and monitor and estimate the powder level 578 (illustrated in FIG. 5B) in the container assembly 544 (illustrated in FIG. 5B). The design of the capacitance sensing circuit 579 can be varied pursuant to the teachings provided herein.

In the non-exclusive implementation of FIG. 5C, the capacitance sensing circuit 579 includes (i) a first integrated circuit 579A (“first IC”) that generates an oscillating wave output 579B that corresponds to the capacitance between the electrode members 554, 556; (ii) a second integrated circuit 579C (“second IC”) that determines and/or monitors a frequency of the oscillating wave output 579B to determine and/or monitor the powder level 578 in the container assembly 544; (iii) a power source 579D (e.g. a direct current power source); (iv) a first resistor 579E (“R1”); (v) a second resistor 579F (“R2”); (vi) a first capacitor 579G (“C1”); (vii) a second capacitor 579H (“C2”); and (viii) a third capacitor 579I (“C3”) that is a compensating capacitor. In this implementation, the first capacitor 579G represents the capacitance between the electrode members 554, 556 in the container assembly 544, and this capacitance varies in conjunction with the powder level 578 in the container assembly 544. As provided herein, depending upon the design, the first capacitor C_{A} and the second capacitor C_{B} can influence the oscillating square wave, but this influence can be minimal. As a result, the third capacitor Cs will be the primary influence driving the frequency of the oscillating square wave. The design of each of the components of the capacitance sensing circuit 579 can be varied pursuant to the teachings provided herein.

In one, non-exclusive implementation, the first integrated circuit 579A is a timer circuit. More specifically, in FIG. 5C, the first integrated circuit 579A can be a 555 timer integrated circuit (IC) that generates a square oscillating wave output 579B. In this example, the first integrated circuit 579A include (i) a power input 579Ac that is connected to the power source 579D; (ii) a discharge 579Ab that is connected between the resistors 579E, 579F; (iii) a threshold 579Ac that receives the capacitance of the first capacitor 579E; (iv) a control voltage 579Ad connected to the second capacitor 579H; (v) a ground 579Ae that is connected to ground; (vi) a trigger 579Af that is connected to the third capacitor 579I and the first capacitor 579G; (vii) an output 579Ag that outputs the oscillating wave output 578B; and (viii) a reset 579Ah connected to the power source 579D.

In the implementation of FIG. 5C, a frequency of the oscillating wave output 578B from the first integrated circuit 579A is dependent on the inputs from (i) the “Trigger” 579Af, (ii) the “Discharge” 579Ab, (iii) the “Threshold” 579Ac, and (iv) the “Control Voltage” 579Ad. In this design, (i) if the resistor values, of the first resistor (R1) 579E, and the second resistor (R2) 579F are fixed; and (ii) the capacitance values of the second capacitor (C2) 579H, and the third capacitor C3 579I are fixed; then the only variable is the first capacitance from the first capacitor (C1) 579G. As provided herein, the first capacitance represents the capacitance between the electrode members 554, 556 in the container assembly 544, and this capacitance varies in conjunction with the powder level 578 in the container assembly 544.

With the capacitance sensing circuit 579 in FIG. 5C, as the powder level 578 in the container assembly 544 increases, the capacitance value of the first capacitor 579G increases, and the frequency of the oscillating wave output 579B of the first integrated circuit 579A decreases. In contrast, as the powder level 578 in the container assembly 544 decreases, the capacitance value of the first capacitor 579G decreases, and the frequency of the oscillating wave output 579B of the first integrated circuit 579A increases. Thus, the first integrated circuit 579A generates the oscillating, wave output 579B that corresponds to the capacitance between the electrode members 554, 556 and the powder level 578. Stated in another fashion, the frequency of the oscillating wave output corresponds to the capacitance between the electrode members 554, 556.

The second integrated circuit 579C receives the oscillating wave output 578B from the output 579Ag and estimates the powder level 578 in the container assembly 544 based on the frequency of the oscillating wave output 579B. In one, non-exclusive implementation, the second integrated circuit 579C includes a field-programmable gate array that is able to determine/monitor the frequency of the oscillating wave output 579B.

In certain implementations, the capacitance sensing circuit 579 needs to be calibrated to determine what frequency of the oscillating wave output 579B corresponds to what powder level 578. For example, during manufacturing, the container assembly 544 can be slowly filled while monitoring the corresponding frequency values of the oscillating wave output 579B. The visual fill level and the corresponding frequency values of the oscillating wave output 579B can be used to generate a look-up table that can subsequently be used during operation to estimate the powder level 578.

It should be noted that there are other ways to measure capacitance of the capacitor 579G formed between the electrode members 554, 556 in the container assembly 544. One way is to attach a known resistor in series with the first capacitor 579G. With this design, starting with a discharged capacitor 579G, the capacitor 579G can be charged to some threshold voltage, V_{TH}. The amount of time required to charge the capacitor 579G to the threshold voltage, V_{TH} can be measured. For example, a microcontroller or an FPGA and a comparator IC can be used to measure the time. The microcontroller or FPGA can first send a signal to a relay to start charging up the capacitor 579G and at the same time the microcontroller or FPGA would begin its timer. The comparator IC will keep checking the voltage on the capacitor 579G and once the voltage on the capacitor reaches V_{TH}, the comparator will send a signal to the microcontroller or FPGA to let it know that V_{TH} has been reached. The timer on the FPGA then stops. Using the charging capacitance equation,

$${V}_{TH} = {V}_{S} ( 1 - {e}^{- \frac{t}{R C}} )$$

where R is the known resistor, V_{S} is voltage from some power supply, t is the time it took to charge up, and C is the unknown capacitance. The unknown capacitance, C, of the capacitor 579G can be derived from this equation.

Another way is to again add a resistor with known resistance in series with the unknown capacitance of capacitor 579G formed between the electrode members 554, 556. Next, a sinusoidal signal with known frequency and amplitude can be sent to the resistor/capacitor network. Subsequently, the voltage across the capacitor 579G can be measured, and the amplitude of the sinusoidal signal noted to see how much the amplitude decreased. Knowing the total impedance (Z), resistor (R), and capacitor reactance, X_{C}, the capacitance value can be determined using the following equations

$$Z = \sqrt{{R}^{2} + {( - {X}_{C} )}^{2}} ; {X}_{C} = \frac{1}{2 * π * f * C} ;$$

$${V}_{DECREASED AMP} = {V}_{ORIGINAL AMP} * ( \frac{{X}_{C}}{Z} ) ) .$$

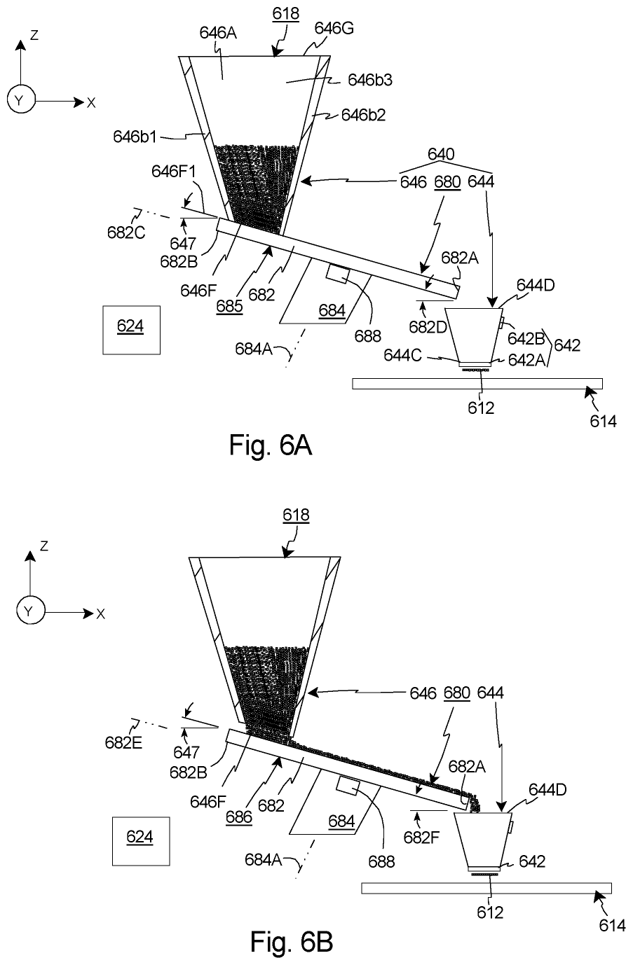

FIG. 6A is a simplified side view, in partial cut-away of another implementation of the powder supply assembly 618 and a powder bed assembly 614 (illustrated as a box) that can be integrated into any of the processing machines 10 described above. In FIG. 6A, the powder supply assembly 618 is a top-down, gravity driven system that is controlled by the control system 624 (illustrated as a box) to selectively and accurately deposit the powder 612 (illustrated with small circles) onto the powder bed assembly 614.

In this implementation, the powder supply assembly 618 includes a powder container assembly 640, and a flow control assembly 642 that is controlled by the control system 624 to selectively and accurately deposit the powder 612 onto the powder bed assembly 614. In FIG. 6A, the flow control assembly 642 is illustrated as being recently activated and the powder supply assembly 618 is releasing the powder 612 towards the powder bed assembly 614.

The powder container assembly 640 retains the powder 612 that is being deposited onto the powder bed assembly 614. In FIG. 6A, the powder container assembly 640 includes (i) a first container subassembly 644 (“fine powder supply”) that retains and deposits the powder 612 onto the powder bed assembly 614; (ii) a second container subassembly 646 (“coarse powder supply”) (illustrated in cut-away) that retains powder 612 that is to be transferred to the first container subassembly 644 to refill the first container subassembly 644; and (iii) a transfer system 680 that transfers powder 612 from the second container subassembly 646 to fill the first container subassembly 644. The design of these components can be varied pursuant to the teachings provided herein. Alternatively, for example, the powder container assembly 640 can be designed to include more than two container subassemblies 644, 646, and the transfer system 680 can be used to transfer powder 612 from any of these container subassemblies 644, 646.

In the non-exclusive implementation of FIG. 6A, (i) the first container subassembly 644 is positioned above the powder bed assembly 614; (ii) the second container subassembly 646 is positioned above and to the side of the first container subassembly 644; and (iii) the transfer system 680 is positioned between the container subassemblies 644, 646. However, these components can be positioned in a different fashion.

In one nonexclusive implementation, the first container subassembly 644 (i) retains the powder 612 prior to distribution onto the powder bed assembly 614; (ii) has a bottom opening 644C for depositing the powder 612 onto the powder bed assembly 612; (iii) has a top opening 644D for refilling with powder 612; (iv) is oriented substantially perpendicular to the powder bed assembly 614; and (v) is aligned with gravity. The first container subassembly 644 can be similar in design to the corresponding component described above.

The flow control assembly 642 is controlled by the control system 624 to selectively release the powder 612 from the bottom opening 644C of the first container subassembly 644. As a non-exclusive example, the flow control assembly 642 can include a flow controller 642A and an activation system 642B that are similar to the corresponding components described above. Alternatively, another type of flow control assembly 642 can be utilized to control the flow of powder 612 from the first container subassembly 644.

The second container subassembly 646 is positioned above and to the side of the first container subassembly 644, and is used to refill and resupply the first container subassembly 644. More specifically, the second container subassembly 646 can define a second container region 646A that retains the powder 612 prior to refilling the first container subassembly 644.

The size and shape of the second container subassembly 646 can be varied to suit the powder 612 supply requirements for the system. In one non-exclusive implementation, the second container subassembly 646 is shaped like a truncated, rectangular shaped tube, and includes four side walls, an open bottom 646F that defines the refill outlet, and an open top 646G that defines an inlet into the second container region 646A. However, other shapes are possible. For convenience, the four side walls can be referred to as a left side wall 646b1, a right side wall 646b2, a back side wall 646b3, and a front side wall (not shown). Any of these walls 646b1-646b3 can be referred to as a first, second, third, etc., wall.

In FIG. 6A, the refill outlet 646F is a rectangular shaped, and the refill outlet 646F is positioned along an outlet plane 646F1 that is inclined relative to the horizontal plane (e. g. the X and Y axis). As provided herein, an outlet inclined angle 647 of the refill outlet 646F and the outlet plane 646F1 relative to horizontal plane can be varied. As alternative, non-exclusive examples, the outlet inclined angle 647 can be between approximately ten and seventy degrees. Stated in another fashion, non-exclusive examples, the outlet inclined angle 647 can be at least approximately 10, 20, 30, 40, 50, 60, or 70 degrees. However, other values are possible. For example, this angle can be zero degrees if the transfer system 680 includes a transfer mechanism as described below.

In this design, the bottom of the right side wall 646b2 is lower than the bottom of the left side wall 646b1, and the bottom of the back side wall 646b3 and the front side wall are tapered from the left side wall 646b1 to the right side wall 646b2. With this design, the walls 646b1-646b3 can cooperate to define the refill outlet 646F that is angularly positioned and rectangular shaped. It should be noted that the inclined angle 647 can be varied to suit the design of the transfer system 680.

The transfer system 680 controls the transfer of the powder 612 from the second container subassembly 646 to the first container subassembly 644. In one implementation, the transfer system 680 includes a transfer slope 682 and a slope actuator assembly 684. The design and positioning of each of these components can be varied pursuant to the teachings provided herein. It should be noted that the transfer slope 682 can also be referred to as a transfer ramp.

In one implementation, the slope actuator assembly 684 selectively controls the position of the transfer slope 682 to selectively control the flow of the powder 612 from the second container subassembly 646 to the first container subassembly 644. In FIG. 6A, the slope actuator assembly 684 has moved the transfer slope 682 to a non-flow position 685 in which the transfer slope 682 inhibits the flow of the powder 612 from the second container subassembly 646.

FIG. 6B is a simplified side view, in partial cut-away of the powder supply assembly 618 and the powder bed assembly 614 of FIG. 6A including the transfer system 680. However, in FIG. 6B, the slope actuator assembly 684 has moved the transfer slope 682 to a flow position 686 in which (i) the powder 612 flows from the refill outlet 646F, and (ii) the transfer slope 682 transfers the powder 612 from the second container subassembly 646 to the first container subassembly 644.

It should be noted that in FIGS. 6A and 6B, the flow control assembly 642 is activated and the first container subassembly 644 is depositing powder 612 onto the powder bed assembly 614.

With reference to FIGS. 6A and 6B, the slope actuator assembly 684 is controlled by the control system 624 to selectively move the transfer slope 682 between the positions 685, 686 to selectively fill the first container subassembly 644 as necessary with powder 612 from the second container subassembly 646. Stated in another fashion, the slope actuator assembly 684 moves the transfer slope 682 between (i) the non-flow position 685 in which powder 612 does not flow from refill outlet 646F and is not transferred to the first container subassembly 644; and (ii) the flow position 686 in which powder 612 flows from refill outlet 646F and is transferred to the first container subassembly 644.

In FIG. 6A, in the non-flow position 685, the transfer slope 682 is positioned adjacent to and directly against the refill outlet 646F to close the refill outlet 646F. Alternatively, in the non-flow position 685, the transfer slope 682 can be positioned slightly spaced apart a small distance from (but still adjacent to) the refill outlet 646F. In this design, the transfer slope 682 is still close enough to the refill outlet 646F to inhibit significant flow from the refill outlet 646F.

In contrast, in the flow position 686, the transfer slope 682 is positioned sufficiently spaced apart from the refill outlet 646F to allow the powder 612 to flow from the refill outlet 646F onto the transfer slope 682.

With the design, the transfer slope 682 functions as both (i) a valve to selectively open and close the refill outlet 646F; and (ii) the slide that moves the powder 612 from below the second container subassembly 646 to the top of the first container subassembly 644. With this design, the transfer slope 682 is a ramp that is positioned on an inclined plane.

The transfer slope 682 is a rigid structure that extends between the refill outlet 646F of the second container subassembly 646 and the open top 644D of the first container subassembly 644. In one, non-exclusive implementation, the transfer slope 682 includes a generally flat plate that has (i) a slope first end 682A that is positioned at least partly above the open top 644D of the first container subassembly 644; and (ii) a slope second end 682B that is positioned completely below the refill outlet 646F of the second container subassembly 646.

In this design, in the non-flow position 685, the transfer slope 682 is sloped and positioned on a first slope plane 682C that is inclined relative to the horizontal plane (e.g. the X and Y axis). As provided herein, in the non-flow position 685, a slope angle 682D of the transfer slope 682 relative to horizontal plane can be similar to (e.g. approximately match or correspond to) the inclined outlet angle 647 described above. Further, in the flow position 686, the transfer slope 682 is sloped and positioned on a second slope plane 682E that is inclined relative to the horizontal plane (e.g. the X and Y axis). As provided herein, in the flow position 686, a second slope angle 682F of the transfer slope 682 relative to horizontal plane can be similar to (e.g. approximately match or correspond to) the inclined outlet angle 647 described above. As alternative, non-exclusive examples, the slope angles 682D, 683F can be between approximately ten and seventy degrees. Stated in another fashion, non-exclusive examples, the slope angles 682D, 683F can be at least approximately 10, 20, 30, 40, 50, 60, or 70 degrees. However, other values are possible. For example, the transfer slope 682 can a conveyer belt or other transfer-assist mechanism. In this example, the angle can be as small as zero.

Additionally, for example, the transfer slope 682 can include side walls (not shown) that guide the flow of the powder 612 down the transfer slope 682.

In the embodiment illustrated, the transfer slope 682 is generally linear. Alternatively, for example, the transfer slope 682 can be non-linear, e.g. curved or have another configuration.

As provided above, the slope actuator assembly 684 selectively moves the transfer slope 682 between the positions 685, 686. The type of movement between the positions 685, 686 can be varied. In the implementation of FIGS. 6A and 6B, the slope actuator assembly 684 is controlled to selectively move the transfer slope 682 linearly along an actuator axis 684A between the flow position 686 and the non-flow position 685. In this design, (i) the transfer slope 682 and the refill outlet 646F can be in parallel and spaced apart planes when the transfer slope 682 is in the flow position 686; and (ii) the transfer slope 682 and the refill outlet 646F are substantially coplanar when the transfer slope 682 is in the non-flow position 685.

Alternatively, the slope actuator assembly 684 can be controlled to selectively move the transfer slope 682 in another fashion between the positions 685, 686.

It should be noted that depending upon the second slope angle 682F, the slope actuator assembly 684 may need to additionally vibrate the transfer slope 682 to move the powder 612 along the transfer slope 682. This will also depend on the coefficient of friction of the transfer slope 682. With this design, as a non-exclusive example, if the second slope angle 682F is relatively large (e.g. greater than forty-five degrees), vibration may not be necessary to move the powder 612 along the transfer slope 682. Alternatively, as a non-exclusive example, if the second slope angle 682F is relatively small (e.g. less than forty-five degrees), vibration of the transfer slope 682 with the slope actuator assembly 684 may be necessary to move the powder 612 along the transfer slope 682 to the first container subassembly 644. However, in alternative designs, vibration may not be necessary at second slope angles 682F that are greater than 30, 35, 38, 40, or 42 degrees.

With the present design, if necessary, the slope actuation system 684 can additionally include a vibration system 688 having one or more vibration generators that are controlled by the control system 624 to selectively vibrate the transfer slope 682. Each vibration generator can include a vibration motor.

With the present design, the problem of limited slide angle of the transfer slope 682 in a two-stage powder supply assembly 618 is solved by designing the transfer slope 682 to also function as (i) the valve to selectively open and close the refill outlet 646F; and (ii) the slide that moves the powder 612 from below the second container subassembly 646 to the top of the first container subassembly 644. As a result thereof, the integrated valve and slide (i) enables steeper slide angle (where space is limited); and (ii) if the angle is sufficiently steep, then vibration is not required to enable powder to slide, thereby decoupling the sliding function from the valve powder-releasing function.

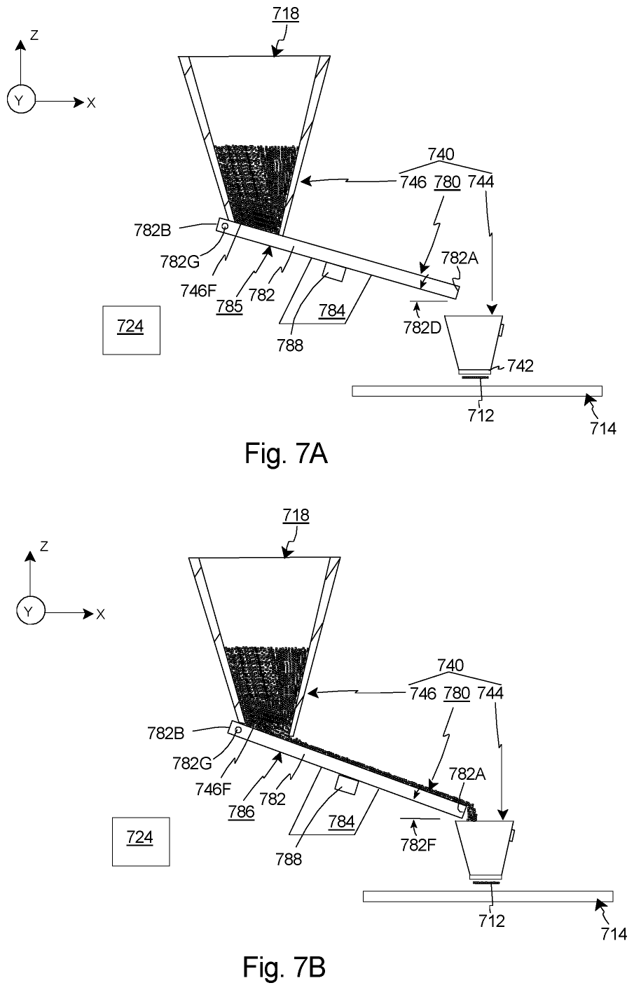

FIG. 7A is a simplified side view, in partial cut-away of still another implementation of the powder supply assembly 718 and a powder bed assembly 714 (illustrated as a box) that can be integrated into any of the processing machines 10 described above. In FIG. 7A, the powder supply assembly 718 and the powder bed assembly 714 are similar to the corresponding components described above in reference to FIGS. 6A and 6B.

In this implementation, the powder supply assembly 718 includes a powder container assembly 740, and a flow control assembly 742 that are similar to the corresponding components. Further, in FIG. 7A, the flow control assembly 742 is illustrated as being recently activated and the powder supply assembly 718 is releasing the powder 712 towards the powder bed assembly 714.

In FIG. 7A, the powder container assembly 740 includes (i) a first container subassembly 744 that retains and deposits the powder 712 onto the powder bed assembly 714; (ii) a second container subassembly 746 (illustrated in cut-away) that retains powder 712 that is to be transferred to the first container subassembly 744 to refill the first container subassembly 744; and (iii) a transfer system 780 that transfers powder 712 from the second container subassembly 746 to fill the first container subassembly 744. The first container subassembly 744 and the second container subassembly 746 are similar to the corresponding components described above. However, the transfer system 780 is slightly different.

More specifically, the transfer system 780 again controls the transfer of the powder 712 from the second container subassembly 746 to the first container subassembly 744. In this implementation, the transfer system 780 again includes a transfer slope 782 and a slope actuator assembly 784 that are somewhat similar to the corresponding components described above.

More specifically, the slope actuator assembly 784 again selectively controls the position of the transfer slope 782 to selectively control the flow of the powder 712 from the second container subassembly 746 to the first container subassembly 744. In FIG. 7A, the slope actuator assembly 784 has moved the transfer slope 782 to the non-flow position 785 in which the transfer slope 782 inhibits the flow of the powder 712 from the second container subassembly 746.

FIG. 7B is a simplified side view, in partial cut-away of the powder supply assembly 718 and the powder bed assembly 714 of FIG. 7A. However, in FIG. 7B, the slope actuator 784 has moved the transfer slope 782 to the flow position 786 in which (i) the powder 712 flows from the refill outlet 746F, and (ii) the transfer slope 782 transfers the powder 712 from the second container subassembly 746 to the first container subassembly 744.

With reference to FIGS. 7A and 7B, (i) in the non-flow position 785, the transfer slope 782 is positioned adjacent to the refill outlet 746F to close the refill outlet 746F; and (ii) in the flow position 786, the transfer slope 782 is positioned sufficiently spaced apart from the refill outlet 746F to allow the powder 712 to flow from the refill outlet 746F onto the transfer slope 782. With the design, the transfer slope 782 again functions as both (i) a valve to selectively open and close the refill outlet 746F; and (ii) the slide that moves the powder 712 from below the second container subassembly 746 to the top of the first container subassembly 744.

Comparing FIGS. 7A and 7B, the slope actuator assembly 784 selectively pivots (rotates) the slope first end 782A relative to the slope second end 782B of the transfer slope 782 about a pivot 782D between the positions 785, 786. Stated in another fashion, (i) in the non-flow position 785, the transfer slope 782 is sloped at a first slope angle 782D relative to the horizontal plane (and can be similar to (e.g. approximately match or correspond to) the inclined outlet angle 647 described above); (ii) in the flow position 786, the transfer slope 782 is sloped at a second slope angle 782F that is different from the first slope angle 782D; and (iii) the slope actuator assembly 784 pivots the transfer slope 782 between the positions 785, 786 to selectively change the slope angle 782D, 782F and control powder 712 flow. With this design, (i) in the non-flow position 785, the transfer slope 782 is used to close the refill outlet 746F; and (ii) in the flow position 786, the transfer slope 782 has been rotated to change the slope inclined angle 782F and open the refill outlet 746F.

Additionally, if necessary, the slope actuation system 784 can include a vibration system 788 having one or more vibration generators that are controlled by the control system 724 to selectively vibrate the transfer slope 782 when the transfer slope 782 is in the flow position 786 to facilitate flow of the powder 712 along the transfer slope 782. Each vibration generator can include a vibration motor.

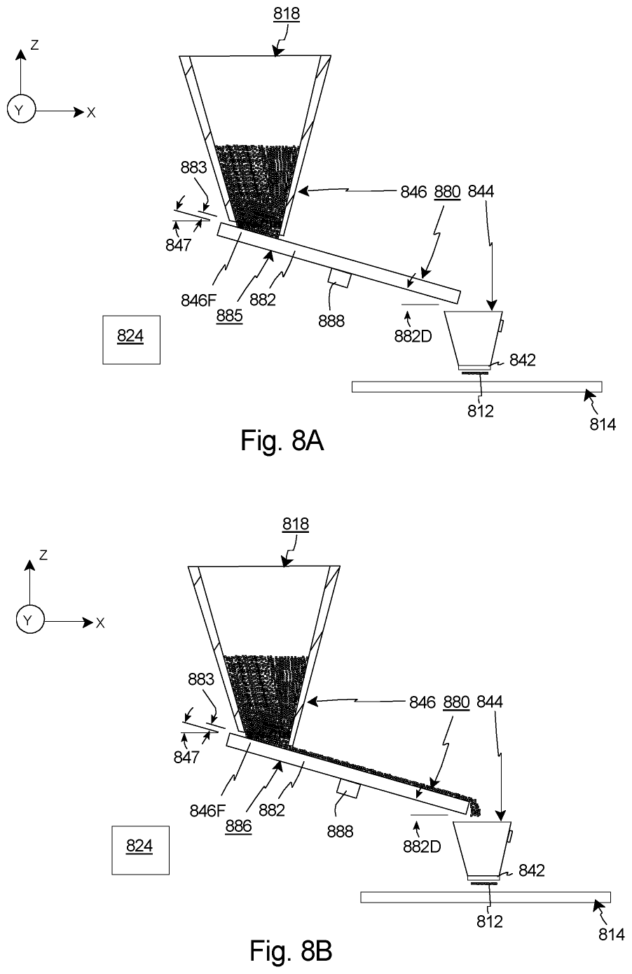

FIG. 8A is a simplified side view, in partial cut-away of still another implementation of the powder supply assembly 818 and a powder bed assembly 814 (illustrated as a box) that can be integrated into any of the processing machines 10 described above. In FIG. 8A, the powder supply assembly 818 and the powder bed assembly 814 are similar to the corresponding components described above in reference to FIGS. 6A and 6B.

In this implementation, the powder supply assembly 818 includes a powder container assembly 840, and a flow control assembly 842 that are similar to the corresponding components. Further, in FIG. 8A, the flow control assembly 842 is illustrated as being recently activated and the powder supply assembly 818 is releasing the powder 812 towards the powder bed assembly 814.

In FIG. 8A, the powder container assembly 840 includes (i) a first container subassembly 844 that retains and deposits the powder 812 onto the powder bed assembly 814; (ii) a second container subassembly 846 (illustrated in cut-away) that retains powder 812 that is to be transferred to the first container subassembly 844 to refill the first container subassembly 844; and (iii) a transfer system 880 that transfers powder 812 from the second container subassembly 846 to fill the first container subassembly 844. The first container subassembly 844 and the second container subassembly 846 are similar to the corresponding components described above. However, the transfer system 880 is slightly different.

More specifically, the transfer system 880 again controls the transfer of the powder 812 from the second container subassembly 846 to the first container subassembly 844. In this implementation, the transfer system 880 includes a transfer slope 882 and a vibration system 888 that are somewhat similar to the corresponding components described above.

However, in this design, the transfer slope 882 is selectively vibrated with the vibration system 888 to selectively control both (i) the flow of the powder 812 from the refill outlet 846F, and (ii) the movement of the powder 812 along the transfer slope 882 to the first container subassembly 844. More specifically, in FIG. 8A, in the non-flow position 885, the vibration system 888 is not sufficiently activated to cause the powder 812 to flow from the refill outlet 846F and/or along the transfer slope 882 to the first container subassembly 844.

FIG. 8B is a simplified side view, in partial cut-away of the powder supply assembly 818 and the powder bed assembly 814 of FIG. 8A. In FIG. 8B, in the flow position 886, the vibration system 888 has been activated to cause (i) the flow of the powder 812 from the refill outlet 846F, and (ii) the movement of the powder 812 along the transfer slope 882 to the first container subassembly 844.

With reference to FIGS. 8A and 8B, in this design, (i) the refill outlet 846F is again at an inclined outlet angle 847; (ii) the slope angle 882D of the transfer slope 882 is the same in both positions 885, 886; (iii) the slope angle 882D can be similar to the outlet angle 847; and (iv) the transfer slope 882 is spaced apart a slope spacing 883 from the refill outlet 846F in both positions 885, 886.

With the present design, the slope spacing 883 is such that (i) when the vibration system 888 is sufficient activated, the powder 812 will flow from the refill outlet 846F and along the transfer slope 882 to the first container subassembly 844; and (ii) when the vibration system 888 is insufficiently activated (e.g. off) the powder 812 will not flow from the refill outlet 846F and will not flow along the transfer slope 882. With this design, the transfer slope 882 and vibration system 888 functions as both (i) a valve to selectively open and close the refill outlet 846F; and (ii) the slide that moves the powder 812 from below the second container subassembly 846 to the top of the first container subassembly 844.

The size of the slope spacing 883 will depend on many factors, including the angles 847, 882D, and the size and type of powder 812, and if the transfer slope 882 is being vibrated during activation. As alternative, non-exclusive examples, the slope spacing 883 can be at least approximately five, eight, ten, twelve or fifteen millimeters.

For example, the vibration system 888 can include one or more spaced apart vibration generators that are controlled by the control system 824 to selectively control the powder 812 flow. Each vibration generator can include a vibration motor.

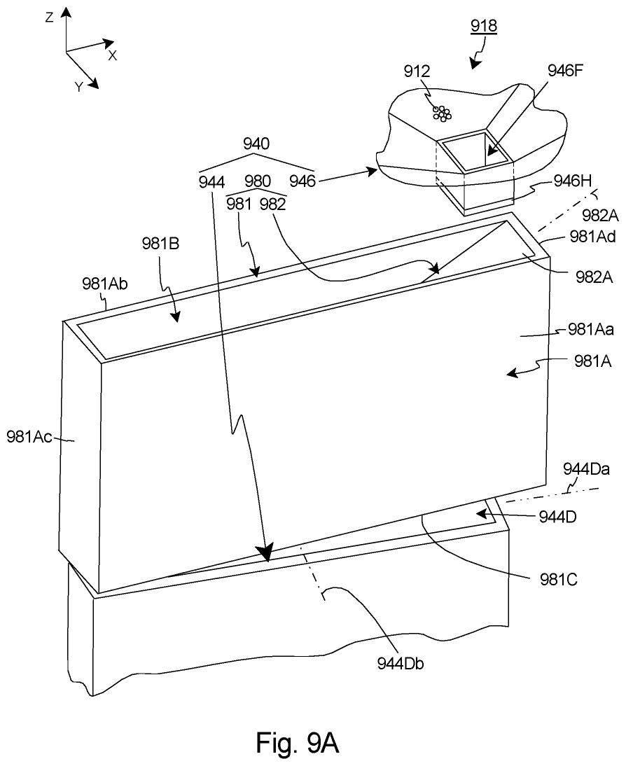

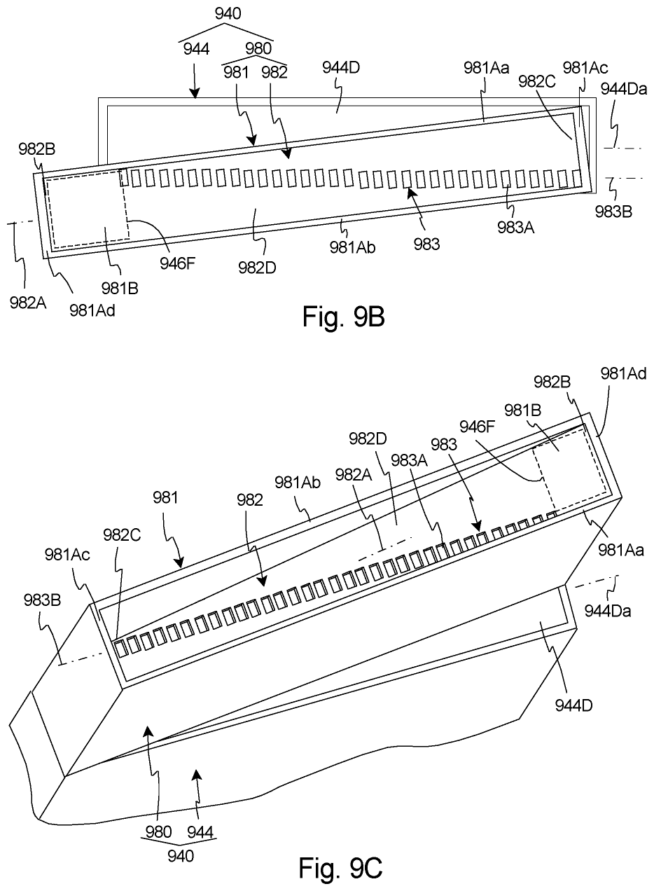

FIG. 9A is a simplified perspective view, of a portion of yet another implementation of the powder supply assembly 918 for depositing powder 912 (illustrated with a few circles) onto a powder bed assembly 614 (illustrated in FIG. 6A) that can be integrated into any of the processing machines 10 described above. In FIG. 9A, the powder supply assembly 918 is a top-down, gravity driven system that is controlled by the control system 624 (illustrated in FIG. 6A) to selectively and accurately deposit the powder 812 (illustrated with small circles) onto the powder bed assembly 614.

In this implementation, the powder supply assembly 918 includes a powder container assembly 940, and a flow control assembly (not shown) that is controlled by the control system 624 to selectively and accurately deposit the powder 912 onto the powder bed assembly 614.

The powder container assembly 940 retains the powder 912 that is being deposited onto the powder bed assembly 614. In FIG. 9A, the powder container assembly 940 includes (i) a first container subassembly 944 (only partly shown) that retains and deposits the powder 912 onto the powder bed assembly 614; (ii) a second container subassembly 946 (only partly shown) that retains powder 912 that is to be transferred to the first container subassembly 944 to refill the first container subassembly 944; and (iii) a transfer system 980 that transfers powder 912 from the second container subassembly 946 to fill the first container subassembly 944. The design of these components can be varied pursuant to the teachings provided herein. Alternatively, for example, the powder container assembly 940 can be designed to include more than two container subassemblies 944, 946, and the transfer system 980 can be used to transfer powder 612 from any of these container subassemblies 944, 946.

In the non-exclusive implementation of FIG. 9A, (i) the first container subassembly 944 is positioned above the powder bed assembly 614; (ii) the second container subassembly 946 is positioned above the first container subassembly 944; and (iii) the transfer system 980 is positioned between the container subassemblies 944, 946. However, each container subassembly 944, 946 and the transfer system 980 can be positioned in a different fashion.

The first container subassembly 944 (i) retains the powder 912 prior to distribution onto the powder bed assembly 614; (ii) has an open bottom (not shown in FIG. 9A) for depositing the powder 912 onto the powder bed assembly 614; (iii) has a container inlet 944D (e.g. an open top) for refilling with powder 912; (iv) is oriented substantially perpendicular to the powder bed assembly 614; and (v) is aligned with gravity.

The first container subassembly 944 can be somewhat similar in design to the corresponding component described above. In the non-exclusive implementation of FIG. 9A, the first container subassembly 944 is generally rectangular tube shaped, and the container inlet 944D is a generally rectangular shaped opening having an opening longitudinal axis 944Da and an opening transverse axis 944Db that is transverse to the opening longitudinal axis 944Da.

The second container subassembly 946 is positioned above the first container subassembly 944, and the transfer system 980, and the second container subassembly 946 is used to refill and resupply the first container subassembly 944.

The size and shape of the second container subassembly 946 can be varied to suit the powder 912 supply requirements for the system. In one non-exclusive implementation, the second container subassembly 946 is shaped like a funnel, and includes an open bottom 946F that defines the refill outlet, and an open top (not shown) that defines an inlet into the second container subassembly 946. However, other shapes are possible.

In the non-exclusive implementation of FIG. 9A, the refill outlet 946F is a rectangular tube shaped. However, other shapes are possible.

Additionally, the second container subassembly 946 can include a container valve 946H (illustrated as a box) that is controlled by the control system 624 to selectively control the flow of the powder 912 from the refill outlet 946F of the second container subassembly 946 to the transfer system 980 and subsequently to the first container subassembly 944. For example, the container valve 946H can include a rectangular plate actuated by a linear or rotary pneumatic, electromagnetic, or shape-memory-metal actuator.

The transfer system 980 transfers the powder 912 from the refill outlet 946F to fill the first container subassembly 944. Stated in another fashion, the transfer system 980 receives the powder 912 that is falling via gravity from the refill outlet 946F and transfers the powder 912 to the first container subassembly 944. Further, the transfer system 980 controls the distribution of the powder 912 from the second container subassembly 946 to the first container subassembly 944. For example, in certain implementations, the transfer system 980 is uniquely designed to distribute the powder 912 substantially evenly along the opening longitudinal axis 944Da of the container inlet 944D of the first container subassembly 944. Moreover, because the powder 912 is better distributed in the first container subassembly 944, the first container subassembly 944 is better able to accurately distribute the powder 912 onto the powder bed assembly 614.

The design of the transfer system 980 can be varied pursuant to the teachings provided herein. In one implementation, the transfer system 980 includes a transfer housing 981, and a transfer slope 982 that cooperate to distribute the powder 912 substantially evenly along the opening longitudinal axis 944Da of the container inlet 944D. In one implementation, the transfer system 980 includes a transfer housing 981, a transfer slope 982 and a slope aperture assembly 983 (illustrated in FIGS. 9B and 9C). The design and positioning of each of these components can be varied pursuant to the teachings provided herein.

The transfer housing 981 supports the transfer slope 982 and guides the powder 912 as it moves along the transfer slope 982. The size, shape, and configuration of the transfer housing 981 can be varied to suit the powder 912 distribution requirements and the shape and configuration of the first container subassembly 944. In the non-exclusive implementation of FIG. 9A, the transfer housing 981 is generally rectangular tube shaped, and includes four side walls 981A that define an open top 981B that receives the powder 912 from the refill outlet 946F, and an open bottom 981C that distributes the powder 912 to the first container subassembly 944. However, other shapes are possible. For convenience, the four side walls 981A can be referred to as a front side wall 981Aa, a rear side wall 981Ab, a left side wall 981Ac, and a right side wall 981Ad. Any of these walls 981A can be referred to as a first, second, third, etc., wall.

The transfer slope 982 is positioned within the transfer housing 911, is at an incline (slope), and extends from the right side wall 981Ad at (or near) the open top 981B to the left side wall 981Ac at (or near) the open bottom 981C along a slope longitudinal axis 982A. Thus, in FIG. 9A, the transfer slope 922 inclines (slopes) as if moves from the right side wall 981Ad to the left side wall 981Ac. With this design, the transfer slope 682 is a ramp that is positioned on an inclined plane.

In the embodiment illustrated, the transfer slope 982 is generally linear. Alternatively, for example, the transfer slope 982 can be non-linear, e.g. curved or have another configuration.

FIG. 9B is a simplified top view of the container assembly 940 of FIG. 9A including the first container subassembly 944 and the transfer system 980 without the second container subassembly 946 (illustrated in FIG. 9A). FIG. 9C is an alternative, simplified top perspective view of the transfer slope 982 and the first container subassembly 944 of the powder container assembly 940 of FIG. 9C.

It should be noted that the refill outlet 946F of the second container subassembly 946 is represented with a dashed box in FIGS. 9B and 9C, for reference. Further, the walls 981AC-981Ad of the transfer housing 981 are labeled for reference. Additionally, it should be noted that the orientation of the container assembly 940 in FIG. 9B is rotated approximately 180 degrees from FIG. 9A.

With reference to FIGS. 9A-9C, the transfer slope 982 is positioned within the transfer housing 911, and is generally rectangular, flat plate shaped. Additionally, the transfer slope 982 includes (i) a first slope end 982B which is positioned at the right side wall 981Ad at (or near) the open top 981B; (ii) a second slope end 982C which is positioned at the left side wall 981Ac at (or near) the open bottom 981C; and (iii) the slope aperture assembly 983 includes one or more slope apertures 983A that extend through the transfer slope 982. With this design, the powder 912 is deposited from the refill outlet 946F onto the transfer slope 982 near the first slope end 982B. Subsequently, the powder 912 moves/slides down the sloped transfer slope 982 (via gravity) toward the second slope end 982C. While the powder 912 is sliding down the sloped transfer slope 982, the powder 912 falls through the transfer slope 982 via the slope apertures 983A and subsequently through the open bottom 981C into the container inlet 944D of the first container subassembly 944.

The design, positioning and number of slope apertures 983AC can be varied according to the design of the powder 912 and the first container subassembly 944. In non-exclusive implementation of FIG. 9B, the transfer slope 982 includes thirty-three spaced apart slope apertures 983AC that extend along an aperture axis 983B that extends diagonally from the right side wall 981Ad to the left side wall 981Ac. Alternatively, the transfer slope 982 can be designed to include more than thirty-three or less than thirty-three slope apertures 983A.

In the illustrated example, the aperture axis 983B is substantially parallel to and spaced apart from the container longitudinal axis 944Da. With this design, while the powder 912 is sliding down the sloped transfer slope 982, (i) the powder 912 falls through the slope apertures 983A at different locations along the transfer slope 982 and into the first container subassembly 944 at different locations along the container longitudinal axis 944Da; and (ii) the transfer system 980 uniformly distributes the powder 912 along the container inlet 944D so that the first container subassembly 944 is filled evenly.

As a result thereof, the problem of uniformly distributing powder 912 to the first container subassembly 944 is solved by adding the slope apertures 983A along the diagonal of the transfer slope 982. In this design, the slope apertures 983A are arranged transverse to the slope longitudinal axis 982A. Stated in another fashion, the aperture axis 983B is transverse to and crosses the slope longitudinal axis 982A.

Stated in yet another fashion, in the illustrated design, the transfer slope 982 is arranged such that (in a top view) the slope apertures 983A are arrayed parallel to the container longitudinal axis 944Da and diagonal to the slope longitudinal axis 982A. With this design, powder 912 from the refill outlet 946F slides down the transfer slope 982 and falls through the slope aperture assembly 983 to be distributed along the container longitudinal axis 944Da of the first container subassembly 944.

Alternatively, the slope apertures 983A can be arranged in a different fashion along the transfer slope 982, as long as the slope apertures 983A are distributed perpendicular to the slope longitudinal axis 982A.

In one implementation, a slope region 982D above the slope apertures 983A is extended upwards to trap powder 912 from overshooting slope apertures 983A. Stated in a different fashion, in this design, the surface of the slope region 982D downstream from the slope apertures 983A can extends upward towards to the open top 981B to inhibit the powder 912 from overshooting the slope apertures 983A.

In the non-exclusive example of FIGS. 9B and 9C, each of the slope apertures 983A is generally rectangular shaped. Alternatively, one or more of the slope apertures 983A can have a different configuration.

The angle of slope of the transfer slope 982 can be varied. As alternative, non-exclusive examples, a slope of the transfer slope 982 can be at least approximately 30, 35, 40, 40, 45, 50, 60, or 70 degrees relative to horizontal. However, other values are possible.

It should be noted that the transfer system 980 can additionally and optionally include one or more vibration actuators (not shown) which are controlled to selectively vibrate the transfer slope 982 to further facilitate flow of the powder 912 down the transfer slope 982 and through the one or more slope apertures 983A.

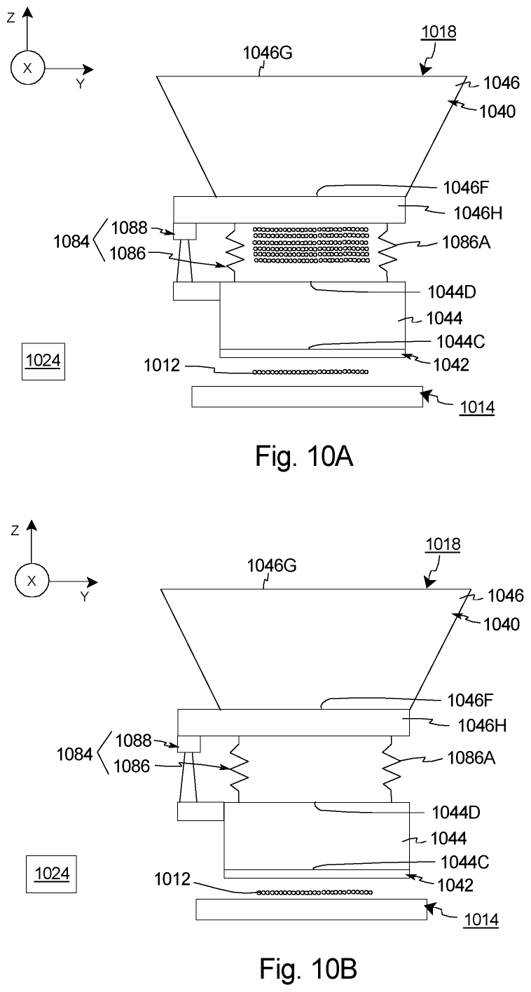

FIG. 10A is a simplified side view, in partial cut-away of still another implementation of the powder supply assembly 1018 for depositing powder 1012 (illustrated with a few circles) onto a powder bed assembly 1014 (illustrated as a rectangle) that can be integrated into any of the processing machines 10 described above. FIG. 10B is a simplified side view, of the powder supply assembly 1018 of FIG. 10A different time.

With reference to FIGS. 10A and 10B, the powder supply assembly 1018 is a top-down, gravity driven system that is controlled by the control system 1024 to selectively and accurately deposit the powder 1012 onto the powder bed assembly 1014.

In this implementation, the powder supply assembly 1018 includes a powder container assembly 1040, and a flow control assembly 1042 (illustrated as a box) that is controlled by the control system 1024 to selectively and accurately deposit the powder 1012 onto the powder bed assembly 1014. The flow control assembly 1042 can be similar to the corresponding components described above. In FIGS. 10A and 10B, the flow control assembly 1042 is depositing the powder 1012 onto the powder bed assembly 1014.

The powder container assembly 1040 retains the powder 1012 that is being deposited onto the powder bed assembly 1014. In FIG. 10A, the powder container assembly 1040 includes (i) a first container subassembly 1044 that retains and deposits the powder 1012 onto the powder bed assembly 1014; (ii) a second container subassembly 1046 that retains powder 1012 that is to be transferred to the first container subassembly 1044 to refill the first container subassembly 1044; and (iii) a refill system 1084 that refills the first container subassembly 1044 with powder 1012 from the second container subassembly 1046 in a closed loop fashion. The design of these components can be varied pursuant to the teachings provided herein. Alternatively, for example, the powder container assembly 1040 can be designed to include more than two container subassemblies 1044, 1046, and the refill system 1084 can be used to transfer powder 1012 from any of these container subassemblies 1044, 1046.

In the non-exclusive implementation of FIG. 10A, (i) the first container subassembly 1044 is positioned above the powder bed assembly 1014; (ii) the second container subassembly 1046 is positioned above the first container subassembly 1044; and (iii) the refill system 1084 is positioned between the container subassemblies 1044, 1046. However, each container subassembly 1044, 1046 and the refill system 1084 can be positioned in a different fashion.

The first container subassembly 1044 (i) retains the powder 1012 prior to distribution onto the powder bed assembly 1014; (ii) has a bottom, refill outlet 1046F for depositing the powder 1012 onto the powder bed assembly 1014; (iii) has a container inlet 1044D (e.g. an open top) for refilling with powder 1012; (iv) is oriented substantially perpendicular to the powder bed assembly 1014; and (v) is aligned with gravity.

The first container subassembly 1044 can be somewhat similar in design to the corresponding component described above. In the non-exclusive implementation of FIGS. 10A and 10B, the first container subassembly 844 is generally rectangular tube shaped, the container outlet 1044C, and the container inlet 1044D is a generally rectangular shaped opening.

The second container subassembly 1046 is positioned above the first container subassembly 1044 and is used to refill and resupply the first container subassembly 1044. The size and shape of the second container subassembly 1046 can be varied to suit the powder 1012 supply requirements for the system. In one non-exclusive implementation, the second container subassembly 1046 is shaped like a truncated tetrahedron, and includes an open bottom 1046F that defines the refill outlet 1046F, and an open inlet 1046G into the second container region 646A. However, other shapes are possible.

In the non-exclusive implementation of FIG. 10A, the refill outlet 1046F can be rectangular tube shaped. However, other shapes are possible.

Additionally, the second container subassembly 1046 can include a container valve 1046H (illustrated as a box) that is controlled by the control system 1024 to selectively control the flow of the powder 1012 from the refill outlet 1046F of the second container subassembly 1046 to the first container subassembly 1044. For example, the container valve 1046H can include a motorized gate that opens or blocks the refill outlet 1046F. In one non-exclusive implementation, the refill outlet 1046F is shaped somewhat like a funnel with a circular outlet (e.g. twenty millimeters inner diameter. In this implementation, the container valve 1046H can be a plate that is controlled to selectively block or open refill outlet 1046F. Further, in this design, the container valve 1046H may not be in direct contact with the refill outlet 1046 to prevent powder getting jammed in narrow spaces.

In FIG. 10A, the container valve 1046H is open and the second container subassembly 1046 is refilling the first container subassembly 1044. Alternatively, in FIG. 10B, the container valve 1046H is closed and the second container subassembly 1046 is not refilling the first container subassembly 1044. Thus, the container valve 1046H selectively controls the flow of the powder 1012 from the second container subassembly 1046 to the first container subassembly 1044.

The refill system 1084 controls the container valve 1046H to refill the first container subassembly 1044 with powder 1012 from the second container subassembly 1046 in a closed loop fashion. The design of the refill system 1084 can be varied pursuant to the teachings provided herein.

In the non-exclusive implementation of FIG. 10A, the refill system 1084 includes a resilient assembly 1086 that resiliently supports the first container subassembly 1044, and a sensor system 1088 that senses the movement and/or position of the first container subassembly 1044. The design of each of these components can be varied.

The resilient assembly 1086 includes one or more resilient member 1086A that support the first container subassembly 1044. In FIG. 10A, two resilient members 1086A are shown that support and couple the first container subassembly 1044 to the second container subassembly 1046. However, the resilient assembly 1086 can include more than two or fewer than two resilient members 1086A. Further, in FIG. 10A, the resilient members 1086A couple and extend directly between the second container subassembly 1046 and the first container subassembly 1044.

The design of each resilient member 1086A can be varied. In FIG. 10A, each resilient member 1086A is in tension and is illustrated as a spring. Alternatively, one or more of the resilient members 1086A can be an elastic member or other flexible member.

The sensor system 1088 senses the movement and/or position of the first container subassembly 1044. With this design, sensor information from the sensor system 1088 can be used to estimate the amount of powder 1012 in the first container subassembly 1044 based on the position of the first container subassembly 1044. For example, the sensor system 1088 can be a displacement sensor that includes one or more interferometers, encodes, or other sensors that provide positional feedback to the control system 1024.

With reference to FIGS. 10A and 10B, because the first container subassembly 1044 is supported by the resilient assembly 1086, the position of the first container subassembly 1044 relative to the second container subassembly 1046 will depend and vary according to the level of powder 1012 in the first container subassembly 1044. Stated in another fashion, (i) as the level of powder 1012 in the first container subassembly 1044 is increased, the resilient assembly 1086 expands and the first container subassembly 1044 moves downward along the Z axis; and (ii) as the level of powder 1012 in the first container subassembly 1044 is decreased, the resilient assembly 1086 retracts and the first container subassembly 1044 moves upward along the Z axis. With this design, the sensor system 1088 provides feedback to the control system 1012 relating to position of the first container subassembly 1044, which can be used to determine the level of powder 1012 in the first container subassembly 1044. Stated in another fashion, the amount of powder 1012 in the first container subassembly 1044 influences the position of the first container subassembly 1044 relative to the second container subassembly 1046. Stated in yet a different fashion, in this implementation, the amount of powder 1012 in the first stage subassembly 1044 is determined by measuring the distance between the first stage subassembly 1044 and the second stage subassembly 1046.

With this design, the first stage subassembly 1044 moves vertically depending on the powder amount. This will change the distance between the powder bed assembly 1014 and the first stage subassembly 1044. It should be noted that the change in distance between the powder bed assembly 1014 and the first stage subassembly 1044 should not a problem if the displacement is sufficiently small (i.e. small enough to not impact powder delivery performance). As a non-exclusive example, the stiffness of the resilient assembly 1086 can be designed such that the vertical travel range does not impact powder delivery from the first container subassembly 1044. In a specific implementation, the stiffness of the resilient assembly 1086 can be fifty gram/millimeter, so for a fifty gram change in weight results in the movement of the first stage subassembly 1044 only one millimeter. Further, the sensor system 1088 with 0.1 millimeter sensitivity would be able to detect five gram changes in weight.

Subsequently, with the sensor information from the sensor system 1088, the control system 1024 can selectively control the container valve 1046H as necessary to maintain the desired level of powder 1012 in the first container subassembly 1044 in a closed loop, automatic fashion.

With this design, the problem of adding a precise amount of powder 1012 to a powder bed assembly 1014 in an automated fashion is solved by using multiple container subassemblies 1044, 1046 with a sensor system 1088 and a resilient assembly 1086 between the container subassemblies 1044, 1046 to transfer powder 1012 from the second container subassembly 1046 to the first container subassembly 1044 when necessary.

As provided herein, the combined mass of the first container subassembly 1044 and the powder 1012 (“combined mass”) cause the resilient members 1086A to elongate a known amount that is a function of the stiffness of the resilient members 1086A and combined mass. The sensor system 1088 measures the position/movement of the first container subassembly 1044. When powder 1012 is removed from the first container subassembly 1044 and released to the powder bed assembly 1014, the combined mass decreases and the first container subassembly 1044 moves upward, closer to the second container subassembly 1046. The sensor system 1088 senses this change. Once the gap between the container subassemblies 1044, 1046 decreases to a predetermined minimum amount, then the control system 1024 controls the container valve 1046G to add powder 1012 to the first container subassembly 1044. This causes the first container subassembly 1044 to move downward, away from the second container subassembly 1046. Powder 1012 is added until the gap between the container subassemblies 1044, 1046 increases to a predetermined maximum amount (as sensed by the sensor system 1088), then the control system 1024 controls the container valve 1046G to stop adding powder 1012 to the first container subassembly 1044.

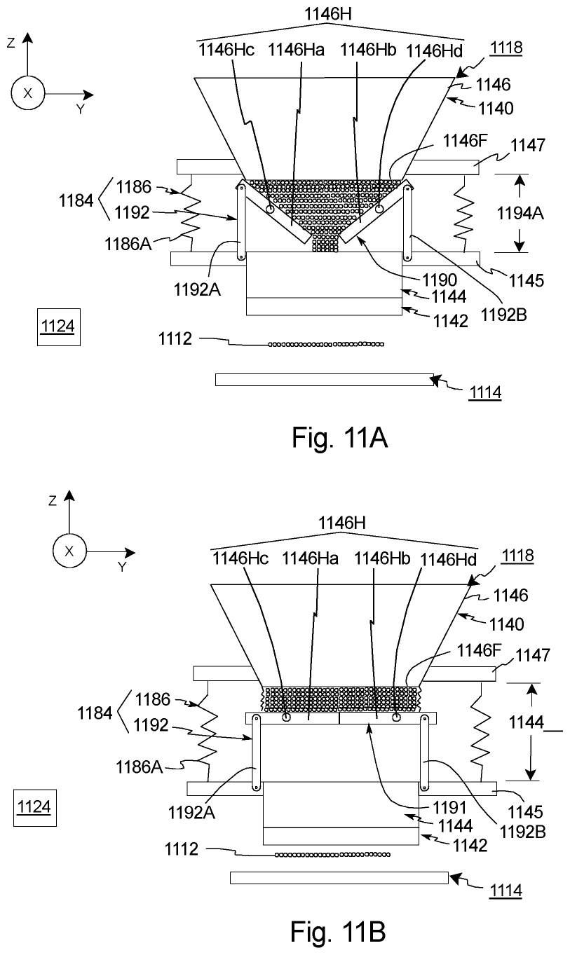

FIG. 11A is a simplified side view, in partial cut-away of still another implementation of the powder supply assembly 1118 for depositing powder 1112 (illustrated with a few circles) onto a powder bed assembly 1114 (illustrated as a rectangle) that can be integrated into any of the processing machines 10 described above. FIG. 11B is a simplified side view, of the powder supply assembly 1118 of FIG. 11A different time.

With reference to FIGS. 11A and 11B, the powder supply assembly 1118 is a top-down, gravity driven system that is controlled by the control system 1124 to selectively and accurately deposit the powder 1112 onto the powder bed assembly 1114.

In this implementation, the powder supply assembly 1118 includes a powder container assembly 1140, and a flow control assembly 1142 (illustrated as a box) that is controlled by the control system 1124 to selectively and accurately deposit the powder 1112 onto the powder bed assembly 1114. The flow control assembly 1142 can be similar to the corresponding components described above. In FIGS. 11A and 11B, the flow control assembly 1142 is activated and depositing the powder 1112 onto the powder bed assembly 1114.

The powder container assembly 1140 retains the powder 1112 that is being deposited onto the powder bed assembly 1114. In FIG. 11A, the powder container assembly 1140 includes (i) a first container subassembly 1144 that retains and deposits the powder 1112 onto the powder bed assembly 1114; (ii) a second container subassembly 1146 that retains powder 1112 that is to be transferred to the first container subassembly 1144 to refill the first container subassembly 1144; and (iii) a refill system 1184 that refills the first container subassembly 1144 with powder 1112 from the second container subassembly 1146 in a closed loop fashion. The design of these components can be varied pursuant to the teachings provided herein. Alternatively, for example, the powder container assembly 1140 can be designed to include more than two container subassemblies 1144, 1146, and the refill system 1184 can be used to transfer powder 1112 from any of these container subassemblies 1144, 1146.

In one non-exclusive implementation, (i) the first container subassembly 1144 is positioned above the powder bed assembly 1114; (ii) the second container subassembly 1146 is positioned above the first container subassembly 1144; and (iii) the refill system 1184 is connected between the container subassemblies 1144, 1146. However, each container subassembly 1144, 1146 and the refill system 1184 can be positioned in a different fashion.

The first container subassembly 1144 and the second container subassembly 1146 can be somewhat similar to the corresponding components described above and illustrated in FIGS. 10A and 10B. In the non-exclusive implementation of FIGS. 11A and 11B, the refill outlet 1146F can be rectangular tube shaped, or another suitable shape.

However, in FIGS. 11A and 11B, the container valve 1146H of the second container subassembly 1146 is different from the previous implementations. More specifically, in this implementation, the container valve 1146H includes a first gate 1146Ha, a second gate 1146Hb, a first gate pivot 1146Hc, and a second gate pivot 1146H. In this non-exclusive design, (i) each gate 1146Ha, 1146Hb is rigid and generally rectangular plate shaped; (ii) the first gate pivot 1146Hc pivotably connects the first gate 1146Ha so that the first gate 1146Ha can selectively pivot relative to the second container subassembly 1146; and (iii) the second gate pivot 1146Hd pivotably connects the second gate 1146Hb so that the second gate 1146Hb can selectively pivot relative to the second container subassembly 1146.

With this design, the gates 1146Ha, 1146Hb are movable (pivotable) between (i) an open configuration 1190 (illustrated in FIG. 11A) in which the powder 1112 flows from the second container subassembly 1146; and (ii) a closed configuration 1191 (illustrated in FIG. 11B) in which the powder 1112 is inhibited from flowing from the second container subassembly 1146. Thus, the container valve 1146H selectively controls the flow of the powder 1112 from the second container subassembly 1146 to the first container subassembly 1144.

The refill system 1184 controls the container valve 1146H to refill the first container subassembly 1144 with powder 1112 from the second container subassembly 1146 in a closed loop fashion. The design of the refill system 1184 can be varied pursuant to the teachings provided herein.

In the non-exclusive implementation of FIGS. 11A and 11B, the refill system 1184 includes a resilient assembly 1186 that resiliently supports the first container subassembly 1144, and a coupler assembly 1192 that couples the gates 1146Ha, 1146Hb to the first container subassembly 1144. The design of each of these components can be varied.

The resilient assembly 1186 includes one or more resilient members 1186A that support the first container subassembly 1144. In FIGS. 11A and 11B, two resilient members 1186A are shown that support and couple the first container subassembly 1144 to the second container subassembly 1146. However, the resilient assembly 1186 can include more than two or fewer than two resilient members 1186A. Further, in FIGS. 11A and 11B, the resilient members 1186A couple and extend between the second container subassembly 1146 and the first container subassembly 1144. In this specific example, the first container subassembly 1144 includes a first flange 1145 and the second container subassembly 1146 includes a second flange 1147; and the resilient members 1186A couple and extend directly between the flanges 1145, 1147.

The design of each resilient member 1186A can be varied. In FIG. 11A, each resilient member 1186A is in tension and is illustrated as a spring. Alternatively, one or more of the resilient members 1186A can be an elastic member or other flexible member.

The coupler assembly 1192 extends between the first container subassembly 1144 (via the first flange 1145) and the gates 1146Ha, 1146Hb. The design of the coupler assembly 1192 can be varied. In the non-exclusive implementation of FIGS. 11A and 11B, the coupler assembly 1192 includes (i) a first coupler 1192A at couples and extends between the first gate 1146Ha and the first container subassembly 1144; and (ii) a second coupler 1192B at couples and extends between the second gate 1146Hb and the first container subassembly 1144. Each coupler 1192A, 1192B can be a rigid link that is pivotably connected to the respective gate 1146Ha, 1146Hb and the first container subassembly 1144. Alternatively, the coupler assembly 1192 can have a different configuration.

With reference to FIGS. 11A and 11B, because the first container subassembly 1144 is supported by the resilient assembly 1186, the position of the first container subassembly 1144 relative to the second container subassembly 1146 will depend and vary according to the level of powder 1112 in the first container subassembly 1144. Stated in another fashion, (i) as the level of powder 1112 in the first container subassembly 1144 is increased, the resilient assembly 1186 expands and the first container subassembly 1144 moves downward along the Z axis; and (ii) as the level of powder 1112 in the first container subassembly 1144 is decreased, the resilient assembly 1186 retracts and the first container subassembly 1144 moves upward along the Z axis.

For example, FIG. 11A illustrates that the first container subassembly 1144 is relatively low on powder 1112, and thus is spaced apart a first gap 1194A from the second container subassembly 1146; and FIG. 11B illustrates that the first container subassembly 1144 has more powder 1112, and is spaced apart a second gap 1194B from the second container subassembly 1146. In this example, the second gap 1194B is larger than the first gap 1194A because the weight of the powder 1112 in the first container subassembly 1144. Thus, the first stage subassembly 1144 moves vertically depending on the amount of powder 1112 in first stage subassembly 1144.

With this design, with the coupler assembly 1192, (i) when the first container subassembly 1144 is spaced apart the first gap 1194A, the coupler assembly 1192 pivots the gates 1146Ha, 1146Hb open, and the powder 1112 flows to fill the first container subassembly 1144; and (ii) when the first container subassembly 1144 is spaced apart the second gap 1194B, the coupler assembly 1192 pivots the gates 1146Ha, 1146Hb closed, and the powder 1112 is inhibited from flowing to the first container subassembly 1144. It should be noted that in certain designs, (i) the gates 1146Ha, 1146Hb will open at a distance intermediate the first gap 1194A and the second gap 1194B; and (ii) that the rotational position of the gates 1146Ha, 1146Hb is dependent upon the position of the first container subassembly 1144, which is depend upon the amount of powder 1112 in the first container subassembly 1144.

As provided herein, the problem of adding a precise amount of powder 1112 to a powder bed assembly 1114 in an automated fashion is solved by using multiple container subassemblies 1144, 1146 with a refill system 1184 and a resilient assembly 1186 between the container subassemblies 1144, 1146 to transfer powder 1112 from the second container subassembly 1146 to the first container subassembly 1144 when necessary.

Stated in yet another fashion, the combined mass of the first container subassembly 1144 and the powder 1112 (“combined mass”) cause the resilient members 1186A to elongate a known amount that is a function of the stiffness of the resilient members 1186A and combined mass. When powder 1112 is removed from the first container subassembly 1144 and released to the powder bed assembly 1114, the combined mass decreases and the first container subassembly 1144 moves upward, closer to the second container subassembly 1146. The coupler assembly 1192 causes the gates 1146Ha, 1146Hb to open. The added powder 1112 causes the first container subassembly 1144 to move downward, away from the second container subassembly 1146. Once the gap 1194A, 1194B between the container subassemblies 1144, 1146 increases sufficiently, the coupler assembly 1192 causes the gates 1146Ha, 1146Hb to close. Thus, the movement of the first container subassembly 1144 away from the second subassembly 1146 causes the coupler assembly 1192 to urge the container valve 1146H to open, and movement of the first container subassembly 1144 towards the second subassembly 1146 causes the coupler assembly 1192 to urge the container valve 1146H to close. In this system, opening size of the container valve 1146H will be a direct function of the gap 1194A, 11946 size. This should allow for the powder 1112 refilling process to be a continuous process that is automatically a closed loop without the need for a sensor.

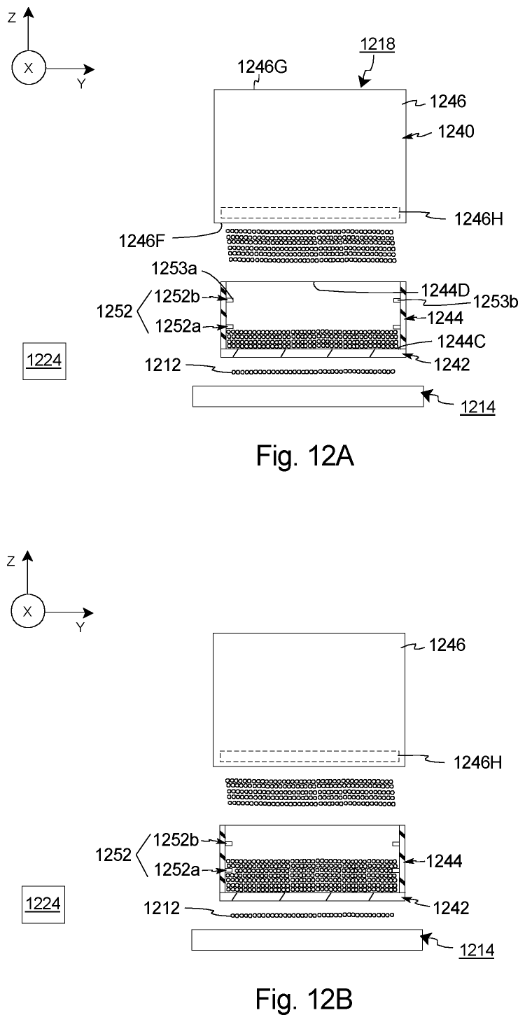

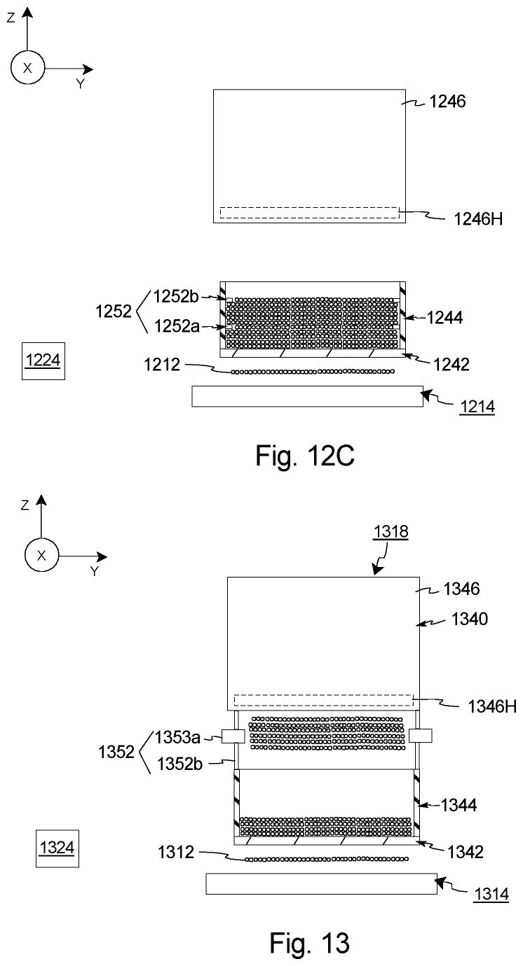

FIG. 12A is a simplified side view, in partial cut-away, of yet another implementation of the powder supply assembly 1218 with a first container subassembly 1244 being refilled, and a powder bed assembly 1214 (illustrated with a square). In FIG. 12A, the powder supply assembly 1218 is depositing powder 1212 (illustrated with a few circles) onto the powder bed assembly 1214. It should be noted that the powder supply assembly 1218 and the powder bed assembly 1214 of FIG. 12A can be integrated into or used in conjunction with any of designs described above.

In FIG. 12A, the powder supply assembly 1218 includes a flow control assembly 1242 that is controlled by a control system 1224 to selectively and accurately deposit the powder 1212 onto the powder bed assembly 1214. Further, the powder supply assembly 1218 can be a top-down, gravity driven system.

As described above, one of the challenges of distributing powder 1212 with the flow control assembly 1242 is that the flow rate can be sensitive to the level of powder 1212 in the first container subassembly 1244. In one implementation, the first container subassembly 1244 additionally includes a powder sensor assembly 1252 that provides feedback regarding the level of the powder 1212 in the first container subassembly 1244. This will allow for the accurate filling of the first container subassembly 1244 and the accurate distribution of powder 1212 onto the powder bed assembly 1214.

The design of the powder supply assembly 1218 can be varied pursuant to the teachings provided herein. In one, non-exclusive implementation, the powder supply assembly 1218 includes a powder container assembly 1240, the flow control assembly 1242, and the powder sensor assembly 1252.

The powder container assembly 1240 retains the powder 1212 that is being deposited onto the powder bed assembly 1214. In FIG. 12A, the powder container assembly 1240 includes (i) a first container subassembly 1244 that retains and deposits the powder 1212 onto the powder bed assembly 1214; and (ii) a second container subassembly 1246 that retains powder 1212 that is to be transferred to the first container subassembly 1244 to refill the first container subassembly 1244. The design of these components can be varied pursuant to the teachings provided herein. Alternatively, for example, the powder container assembly 1240 can be designed to include more than two container subassemblies 1244, 1246.

In the non-exclusive implementation of FIG. 12A, (i) the first container subassembly 1244 is positioned above the powder bed assembly 1214; and (ii) the second container subassembly 1246 is positioned above the first container subassembly 1244. However, each container subassembly 1244, 1246 can be positioned in a different fashion.

The first container subassembly 1244 (i) retains the powder 1212 prior to distribution onto the powder bed assembly 1214; (ii) has a bottom, container outlet 1244C for depositing the powder 1012 onto the powder bed assembly 1214; (iii) has a container inlet 1244D (e.g. an open top) for refilling with powder 1212; (iv) is oriented substantially perpendicular to the powder bed assembly 1214; and (v) is aligned with gravity.

The first container subassembly 1244 can be somewhat similar in design to the corresponding component described above. In the non-exclusive implementation of FIG. 12A, (i) the first container subassembly 1244 is generally rectangular box shaped, and (ii) the container outlet 1244C, and the container inlet 1244D are a generally rectangular opening shaped. However, other shapes and/or configurations are possible.

The second container subassembly 1246 can be somewhat similar in design to the corresponding component described above. In FIG. 12A, the second container subassembly 1246 is positioned above the first container subassembly 1244 and is used to refill and resupply the first container subassembly 1244. The size and shape of the second container subassembly 1246 can be varied to suit the powder 1212 supply requirements for the system. In one non-exclusive implementation, the second container subassembly 1246 is shaped like a rectangular box, and includes an open bottom 1246F that defines a refill outlet 1246F, and an open inlet 1246G for refilling the second container subassembly 1246. However, other shapes are possible.

Additionally, the second container subassembly 1246 can include a container valve 1246H (illustrated as a box in phantom) that is controlled by the control system 1224 to selectively control the flow of the powder 1212 from the refill outlet 1246F of the second container subassembly 1246 to the first container subassembly 1244. As a non-exclusive example, the container valve 1246H can include a motorized gate that opens or blocks the refill outlet 1246F. In this implementation, the container valve 1246H can be a plate that is controlled (e.g., selectively moved with an actuator) to selectively block or open refill outlet 1246F.

In FIG. 12A, the container valve 1246H is open (or partly open) and the second container subassembly 1246 is refilling the first container subassembly 1244. Thus, the container valve 1246H selectively controls the flow of the powder 1212 from the second container subassembly 1246 to the first container subassembly 1244.

The flow control assembly 1242 can be similar to the corresponding component described above. In FIG. 12A, the flow control assembly 1242 is controlled by the control system 1224 to be depositing the powder 1212 onto the powder bed assembly 1214.

The design of the powder sensor assembly 1252 can be varied pursuant to the teachings provided herein. In the non-exclusive implementation of FIG. 12A, the powder sensor assembly 1252 includes (i) a lower level sensor 1252a that measures when the powder level in the first container subassembly 1244 is below a predetermined lower level; and (ii) an upper level sensor 1252b that measures when the powder level in the first container subassembly 1244 is above a predetermined upper level. With this design, (i) the lower level sensor 1252a provides lower powder level information to the control system 1224; and (ii) the upper level sensor 1252b provides upper powder level information to the control system 1224. Using this information, the control system 1224 can control the container valve 1246H to accurately fill the first container subassembly 1244 in a closed loop fashion.

Alternatively, the powder sensor assembly 1252 can be designed to include more than two or fewer than two sensors 1252a, 1252b. In FIG. 12A, the sensors 1252a, 1252b are installed on a low limit point and a high limit point. Additionally, or alternatively, for example, one or more sensors 1252a, 1252b can be positioned on each corner such as left and right ends of the first container subassembly 1244.

Additionally, or alternatively, the powder sensor assembly 1252 can be added to the second container subassembly 1246.

The design or each level sensor 1252a, 1252b can be varied pursuant to the teachings provided herein. In one non-exclusive implementation, one or both of the level sensors 1252a, 1252b is an optical limit switch, e.g., an optical limit switch. These switches are robust, reliable, and relatively inexpensive.

In FIG. 12A, each optical limit switch 1252a, 1252b includes a first switch component 1253a and a spaced apart, second switch component 1253b that can be secured to the first container subassembly 1244 or to another location. In one implementation, the first switch component 1253a generates and directs a light beam (e.g., an infrared light beam) across the first container subassembly 1244 at the second switch component 1253b which includes a receiver. In this design, if that light beam is broken (e.g., by the powder 1212), the optical limit switch will provide that information to the control system 1224. With this design, (i) the lower level sensor 1252a can detect when the powder 1212 is above or below the lower powder level; and (ii) the upper level sensor 1252b can detect when the powder 1212 is above or below the upper powder level.

FIG. 12B is a simplified side view, in partial cut-away, of the powder supply assembly 1218 at a later time, with the first container subassembly 1244 still being refilled from the second container subassembly 1246, and the powder bed assembly 1214. At this time, the powder 1212 is above the lower predetermined level as monitored by the lower level sensor 1252a, and the powder 1212 is below the upper predetermined level as monitored by the upper level sensor 1252b.

FIG. 12C is a simplified side view, in partial cut-away, of the powder supply assembly 1218 with the first container subassembly 1244 being full, and the powder bed assembly 1214. At this time, the powder 1212 is above both the lower predetermined level as monitored by the lower level sensor 1252a, and the upper predetermined level as monitored by the upper level sensor 1252b. As a result thereof, the container valve 1246H is controlled by the control system 1224 to be closed.

One operation of the container valve 1246H can be explained with reference to FIGS. 12A-12C. For example, as illustrated in FIG. 12A, when the powder 1212 is below the lower predetermined level as monitored by the lower level sensor 1252a, the control system 1224 can open the container valve 1246H to add powder 1212 to the first container subassembly 1244. Further, as illustrated in FIG. 12B, the control system 1224 can maintain the container valve 1246H open to continue to add powder 1212 to the first container subassembly 1244 while the powder 1212 is below the upper predetermined level as monitored by the upper level sensor 1252b. Subsequently, as illustrated in FIG. 12C, the control system 1224 can control the container valve 1246H to close to stop the addition of powder 1212 to the first container subassembly 1244 when the powder 1212 is above the upper predetermined level as monitored by the upper level sensor 1252b. Moreover, the control system 1224 can maintain the container valve 1246H closed until the powder 1212 is below the lower predetermined level as monitored by the lower level sensor 1252a. With this design, the control system 1224 can control the container valve 1246H and refill the first container subassembly 1244 in a closed loop fashion.

With this design, the problem of adding a precise amount of powder 1212 to a powder bed assembly 1214 in an automated fashion is solved by using multiple container subassemblies 1244, 1246 with a powder sensor assembly 1252 to transfer powder 1212 from the second container subassembly 1246 to the first container subassembly 1244 when necessary.

FIG. 13 is a simplified side view, in partial cut-away, of yet another implementation of the powder supply assembly 1318 with a first container subassembly 1344 being refilled, and a powder bed assembly 1314 (illustrated with a square). In FIG. 13, the powder supply assembly 1318 is depositing powder 1312 (illustrated with a few circles) onto the powder bed assembly 1314. It should be noted that the powder supply assembly 1318 and the powder bed assembly 1314 of FIG. 13 can be integrated into or used in conjunction with any of designs described above.

In FIG. 13, the powder supply assembly 1318 includes a flow control assembly 1342 that is controlled by a control system 1324 to selectively and accurately deposit the powder 1312 onto the powder bed assembly 1314. Further, the powder supply assembly 1318 can be a top-down, gravity driven system.

As described above, one of the challenges of distributing powder 1312 with the flow control assembly 1342 is that the flow rate can be sensitive to the level of powder 1312 in the first container subassembly 1344. In this implementation, the first container subassembly 1344 additionally includes a powder sensor assembly 1352 that provides feedback regarding the level of the powder 1312 in the first container subassembly 1344. This will allow for the accurate filling of the first container subassembly 1344 and the accurate distribution of powder 1312 onto the powder bed assembly 1314.

The design of the powder supply assembly 1318 can be varied pursuant to the teachings provided herein. In one, non-exclusive implementation, the powder supply assembly 1318 includes a powder container assembly 1340, the flow control assembly 1342, and the powder sensor assembly 1352.

In FIG. 13, the powder container assembly 1340 includes (i) a first container subassembly 1344 that retains and deposits the powder 1312 onto the powder bed assembly 1314; and (ii) a second container subassembly 1346 that retains powder 1312 that is to be transferred to the first container subassembly 1344 to refill the first container subassembly 1344. Alternatively, for example, the powder container assembly 1340 can be designed to include more than two container subassemblies 1344, 1346.

In the non-exclusive implementation of FIG. 13, (i) the first container subassembly 1344, and (ii) the second container subassembly 1346 can be similar to the designs described above.

Additionally, similar to the embodiments above, the second container subassembly 1346 can include a container valve 1346H (illustrated as a box in phantom) that is controlled by the control system 1324 to selectively control the flow of the powder 1312 to the first container subassembly 1344. The container valve 1346H can be similar to the corresponding component described above.

In FIG. 13, the container valve 1346H is open (or partly open) and the second container subassembly 1346 is refilling the first container subassembly 1344. Thus, the container valve 1346H selectively controls the flow of the powder 1312 from the second container subassembly 1346 to the first container subassembly 1344.

The flow control assembly 1342 can be similar to the corresponding component described above. In FIG. 13, the flow control assembly 1342 is controlled by the control system 1324 using feedback from the powder sensor assembly 1352.

The design of the powder sensor assembly 1352 can be varied pursuant to the teachings provided herein. In the non-exclusive implementation of FIG. 13, the powder sensor assembly 1352 includes one or more, spaced apart mass sensors 1352a (two are shown). For example, each mass sensor 1352a can include a strain gauge element that is incorporated into the mounting and supporting of the first container subassembly 1344. With this design, the mass sensor(s) 1352a can be used to directly monitor the mass of the first container subassembly 1344. Stated in another fashion, the sensor assembly 1352 can be used to estimate a level or an amount of the powder 1312 in the first container subassembly 1344.

Using this information, the control system 1324 can control the container valve 1346H to accurately fill the first container subassembly 1344 in a closed loop fashion to maintain the desired mass of the first container subassembly 1344.

In the non-exclusive implementation of FIG. 13, a connector assembly 1352b (e.g., one or more beams) connects the mass sensors 1352b between the second container subassembly 1346 and the first container subassembly 1344, and the second container subassembly 1346 supports the first container subassembly 1344. Alternatively, for example, the first container subassembly 1344 can be supported via the mass sensor(s) 1352a independently of the second container subassembly 1346.

It should be noted that the design in FIG. 13, enables relatively simple switching to any type of powder 1312 without hardware changes. Instead, a powder change may only require changing settings in the control system 1324.

Additionally, or alternatively, the powder sensor assembly 1352 can be added to the second container subassembly 1346.

It is understood that although a number of different embodiments of the powder supply assembly have been illustrated and described herein, one or more features of any one embodiment can be combined with one or more features of one or more of the other embodiments, provided that such combination satisfies the intent of the present disclosure.

While a number of exemplary aspects and embodiments of the processing machine 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A sensor assembly for estimating a level or an amount of a dielectric powder in a container assembly, the sensor assembly comprising:
a first electrode member that is coupled to the container assembly;
a second electrode member that is coupled to the container assembly, the second electrode member being spaced apart from the first electrode member and configured so that powder in the container assembly is positioned at least partly between the electrode members; and
a control system that utilizes a capacitance between the electrode members to estimate the level or an amount of the powder in the container assembly.

2. The sensor assembly of claim 1 wherein the control system includes a first integrated circuit that generates an oscillating wave output that corresponds to the capacitance between the electrode members.

3. The sensor assembly of claim 2 wherein the first integrated circuit generates an oscillating, square wave output that corresponds to the capacitance between the electrode members.

4. The sensor assembly of claim 2 wherein the control system includes a second integrated circuit that determines a frequency of the oscillating wave output.

5. The sensor assembly of claim 4 wherein the second integrated circuit includes a field-programmable gate array and wherein the control system estimates the level or amount of the powder in the container assembly based on the frequency of the oscillating wave output.

6. A powder supply assembly for supplying powder to a build platform of a processing machine for building a three-dimensional object from a dielectric powder, the powder supply assembly including a container assembly that retains the powder, and the sensor assembly of claim 1 coupled to the container assembly, the level sensor assembly estimating the level of the dielectric powder in the container assembly.

7. A powder supply assembly for supplying powder to a build platform of a processing machine for building a three-dimensional object from the powder, the powder supply assembly comprising:
a container subassembly that deposits the powder on the build platform and
a sensor assembly for estimating a level or an amount of the powder in the container assembly.

8. The powder supply assembly of claim 7 wherein the container assembly includes a first container subassembly and a second container subassembly; wherein the sensor assembly estimates the level of the dielectric powder in at least one of the container subassemblies.

9. The powder supply assembly of claim 7 wherein the sensor assembly includes an optical limit switch.

10. A processing machine for building a three-dimensional object from powder, the processing machine comprising: (i) a build platform; (ii) the powder supply assembly of claim 7; and (iii) an energy system that directs an energy beam at a portion of the powder on the build platform to form a portion of the object.

11. The powder supply assembly of claim 7 wherein the sensor assembly includes a mass sensor.

12. A powder supply assembly for supplying powder to a build platform of a processing machine for building a three-dimensional object from the powder, the powder supply assembly comprising:
a first container subassembly;
a second container subassembly that retains the powder, the second container subassembly including a refill outlet; and
a transfer system that transfers powder from the second container subassembly to the first container subassembly, the transfer system including a transfer slope, and a slope actuator assembly that moves the transfer slope between (i) a non-flow position in which powder does not flow from the refill outlet and is not transferred to the first container subassembly; and (ii) a flow position in which powder flows from refill outlet and is transferred to the first container subassembly.

13. The powder supply assembly of claim 12 wherein in the non-flow position, the transfer slope is positioned adjacent to the refill outlet and wherein in the flow position, the transfer slope is positioned spaced apart from the refill outlet.

14. The powder supply assembly of claim 12 wherein the slope actuator assembly moves the transfer slope linearly between the flow position and the non-flow position.

15. The powder supply assembly of claim 12 wherein the slope actuator pivots the transfer slope between the flow position and the non-flow position.

16. The powder supply assembly of claim 12 wherein the refill outlet is an outlet angle, and wherein in the non-flow position, the transfer slope is at a first slope angle that is approximately equal to the outlet angle, and wherein in the flow position, the transfer slope is at a second slope angle that is approximately equal to the outlet angle.

17. The powder supply assembly of claim 16 wherein in the flow position, the transfer slope is at a second slope angle that is different from the outlet angle.

18. The powder supply assembly of claim 12 further comprising a sensor assembly that estimates a powder level in at least one of the container subassemblies.

19. A processing machine for building a three-dimensional object from powder, the processing machine comprising: (i) a build platform; (ii) the powder supply assembly of claim 12; and (iii) an energy system that directs an energy beam at a portion of the powder on the build platform to form a portion of the object.

20. A powder supply assembly for supplying powder to a build platform of a processing machine for building a three-dimensional object from the powder, the powder supply assembly comprising:
a first container subassembly;
a second container subassembly that retains the powder, the second container subassembly including a refill outlet; and
a transfer system that transfers powder from the second container subassembly to the first container subassembly, the transfer system including a transfer slope, and a vibration system that selectively vibrates the transfer slope to selectively control the flow of the powder from the refill outlet of the second container subassembly.

21. The powder supply assembly of claim 20, wherein the transfer slope is positioned spaced apart from the refill outlet.

22. The powder supply assembly of claim 20 wherein the refill outlet is at an outlet angle, and wherein the transfer slope is at a slope angle that is approximately equal to the outlet angle.

23. The powder supply assembly of claim 20 further comprising a sensor assembly that monitors a powder level in at least one of the container subassemblies.

24. A processing machine for building a three-dimensional object from powder, the processing machine comprising: (i) a build platform; (ii) the powder supply assembly of claim 20; and (iii) an energy system that directs an energy beam at a portion of the powder on the build platform to form a portion of the object.

25. A powder supply assembly for supplying powder to a build platform of a processing machine for building a three-dimensional object from the powder, the powder supply assembly comprising:
a first container subassembly having a container inlet having a container longitudinal axis;
a second container subassembly that retains the powder, the second container subassembly including a refill outlet; and
a transfer system that receives powder from the refill outlet and transfers the powder to the first container subassembly, the transfer system including (i) a transfer slope that extends from the refill outlet to the container inlet, and (ii) a slope aperture assembly; wherein powder from the refill outlet slides down the transfer slope and falls through the slope aperture assembly to be distributed along the container longitudinal axis of the container inlet.

26. The powder supply assembly of claim 25 wherein the slope aperture assembly includes at least one slope aperture that extends through the transfer slope.

27. The powder supply assembly of claim 25 wherein the slope aperture assembly includes a plurality of slope apertures that extends through the transfer slope, wherein the slope apertures are spaced apart along an aperture axis.

28. The powder supply assembly of claim 27 wherein the aperture axis is substantially parallel to the container longitudinal axis.

29. The powder supply assembly of claim 27 wherein the aperture axis is diagonal to a slope longitudinal axis of the transfer slope.

30. The powder supply assembly of claim 25 further comprising a sensor assembly that monitors a powder level in at least one of the container subassemblies.

31. A processing machine for building a three-dimensional object from powder, the processing machine comprising: (i) a build platform; (ii) the powder supply assembly of claim 25; and (iii) an energy system that directs an energy beam at a portion of the powder on the build platform to form a portion of the object.

32. A powder supply assembly for supplying powder to a build platform of a processing machine for building a three-dimensional object from the powder, the powder supply assembly comprising:
a first container subassembly that deposits the powder on the build platform, the first container subassembly having a container inlet;
a second container subassembly that retains the powder, the second container subassembly including a refill outlet; and
a resilient assembly that supports the first container subassembly.

33. The powder supply assembly of claim 32 wherein the amount of powder in the first container subassembly influences a position of the first container subassembly relative to the second container subassembly.

34. The powder supply assembly of claim 33 further comprising a sensor system that estimates the amount of powder in the first container subassembly based on the position of the first container subassembly.

35. The powder supply assembly of claim 32, wherein the resilient assembly couples the first container subassembly to the second container subassembly.

36. The powder supply assembly of claim 32 further comprising a container valve that selectively controls the flow of the powder from the second container subassembly to the first container subassembly.

37. The powder supply assembly of claim 36 further comprising a coupler assembly that couples the first container subassembly to the container valve.

38. The powder supply assembly of claim 37 wherein movement of the first container subassembly away from the second subassembly causes the coupler assembly to urge the container valve to open, and movement of the first container subassembly towards the second subassembly causes the coupler assembly to urge the container valve to close.

39. A processing machine for building a three-dimensional object from powder, the processing machine comprising: (i) a build platform; (ii) the powder supply assembly of claim 32 that deposits powder onto the build platform; and (iii) an energy system that directs an energy beam at a portion of the powder on the build platform to form a portion of the object.
